(19) United States
(12) Patent Application Publication
(10) Pub. No.: US 2023/0215714 A1
(43) Pub. Date: Jul. 6, 2023

(54) PLASMA AND SAMPLING GEOMETRIES FOR IMAGING MASS CYTOMETRY

(71) Applicant: Standard BioTools Canada Inc., Markham (CA)

(72) Inventors: Adam Carew, Toronto (CA); Daaf Sandkuijl, Markham (CA); Alexander Loboda, Thornhill (CA); Matthew Weel, Markham (CA); Dmitry Bandura, Aurora (CA)

(73) Assignee: Standard BioTools Canada Inc., Markham, ON (CA)

(21) Appl. No.: 17/785,887

(22) PCT Filed: Dec. 21, 2020
(86) PCT No.: PCT/US2020/066488

§ 371 Date: Jun. 15, 2022

Related U.S. Application Data
(60) Provisional application No. 62/951,556, filed on Dec. 20, 2019.
(60) Provisional application No. 63/114,313, filed on Nov. 16, 2020.

(51) Int. Cl. H01J 49/00; H01J 49/40; H01J 49/04

(52) U.S. Cl. CPC H01J 49/0004; H01J 49/40; H01J 49/0463

(57) ABSTRACT

Described herein are systems and methods for imaging mass spectrometry, including imaging mass cytometry. Aspects of the subject application include apparatus and methods for imaging mass spectrometry (IMS) that improve speed of sample acquisition, signal sensitivity, and/or signal stability. Systems and methods described herein may minimize the transfer time and/or may minimize the spread of plumes of sample material ablated from a sample to be transferred to the components of the imaging mass spectrometer or mass cytometer that ionize and analyze the sample material.

### CROSS-REFERENCE TO RELATED APPLICATIONS

This application claims the benefit of priority to U.S. Provisional Application No. 63/114,313, filed Nov. 16, 2020 and U.S. Provisional Application No. 62/951,556, filed Dec. 20, 2019, the contents of both of which are incorporated herein by reference for all purposes.

### BACKGROUND OF THE INVENTION

Imaging mass spectrometry applications, such as imaging mass cytometry, benefit from rapid acquisition of distinct ablation plumes. For example, a laser ablation ICP-MS system may ablate spots on the order of 1 micron in diameter, and may separately detect the elemental or isotopic composition of millions of spots in a single sample. Quick delivery of ablation plumes with minimal transient spreading allows for rapid analysis of many ablation spots and may improve sensitivity. Turbulence caused by a change in orientation of plume transport compared to the direction of plume expansion during formation may increase transient spreading. Components of the system, such as optical components, may block rapid injection of the plume to a plasma source. In addition, modifications to traditional composition of gas flow may improve signal sensitivity and/or stability.

### TECHNICAL FIELD

This invention relates to apparatus and methods for laser ablation based imaging mass spectrometry, including imaging mass cytometry.

### BRIEF SUMMARY OF THE INVENTION

In the present invention, the inventor has devised numerous developments of existing laser ablation-based imaging mass cytometers and imaging mass spectrometers. In particular, these developments relate to modifications that minimize the transfer time and/or minimize the spread of plumes of sample material ablated from a sample to be transferred to the components of the imaging mass spectrometer or mass cytometer that ionize and analyze the sample material.

The apparatus of the invention, such as an imaging mass spectrometer or an imaging mass cytometer, typically comprises three components. The first is a laser ablation system for the generation of plumes of vaporous and particulate material from the sample for analysis. Before the atoms in the plumes of ablated sample material (including any detectable labelling atoms as discussed below) can be detected by a mass spectrometer component (MS component; the third component), the sample must be atomized and ionized (some ionization of the sample material may occur upon ablation, but space charge effects result in the neutralization of the charges well before they can be detected, thus the apparatus requires a separate ionization component). Accordingly, the apparatus comprises a second component which is an ionization system that ionizes the atoms to form elemental ions to enable their detection by the MS component based on mass/charge ratio. Between the laser ablation system and the ionization system is a transfer conduit, adapted to couple the laser ablation system with the ionization system; the transfer conduit having an inlet positioned within the laser ablation system, the inlet being configured for capturing the ablated plume as the ablated plume is generated; and for transferring the captured ablated plume to the ionization system (in some instances, such as where the ionization system is a plasma, such as an inductively coupled plasma (ICP), the transfer conduit is the same conduit which introduces the sample directly into the ICP torch through the central injector tube, and in this instance the transfer conduit can be termed an injector). Thus in operation, the sample is taken into the apparatus, is ablated to generate vaporous/particulate material, which is ionized by the ionization system, and the ions of the sample are passed into the MS component. Although the MS component can detect many ions, most of these will be ions of the atoms that naturally make up the sample. In some applications, for example analysis of minerals, such as in geological or archaeological applications, this may be sufficient. In imaging mass spectrometry applications such as imaging mass cytometry, the MS component may be a time of flight (TOF) or a magnetic sector MS.

Accordingly, the invention provides an apparatus comprising:

(i) a laser ablation system, adapted to generate plumes of sample material from a sample;

(ii) a plasma source, adapted to receive material removed from the sample by the laser ablation system and to ionize said material to form elemental ions;

(iii) a mass spectrometer to receive elemental ions from said ionization system and to analyze said elemental ions,

wherein the laser ablation system and the ionization system are coupled together by a transfer conduit, adapted to carry a flow of gas containing plumes of ablated sample material from the laser ablation system to the ionization system, and wherein the plasma is not oriented on the same axis as the sample stage.

The invention also provides an apparatus comprising:

a sample stage configured to move a sample in at least two directions, a laser ablation source configured to ablate a sample mounted on the sample stage, a plasma source, an injector configured to transport ablation plumes produced from the sample by the laser ablation source to the plasma source, wherein at least one of the plasma source and the sample stage are oriented orthogonally to one another. For example, the plasma may be oriented more than 60 degrees, more than 70 degrees, or more than 80 degrees, such as 90 degrees away from any axis of the sample stage (the axes of a planar sample mounted on the sample stage).

In certain aspects, therein the injector is rigid and/or straight. An inner diameter of the injector may be less than 2 mm, less than 1 mm, or less than 0.5 mm. The injector length is less than 20 cm, less than 10 cm, less than 5 cm, or less than 3 cm. The apparatus may be configured to direct the laser on a path that does not pass through the injector.

Wherein the apparatus may be operable to deliver at least 500, 1000, 5000, 10000, or 50000 discreet ablation plumes to the ICP source per second. In certain aspects, a short plasma (e.g., less than 5 mm, less than 3 mm, less than 2 mm long) may help prevent transient spread and may allow ions from separate ablation plumes to remain distinct up to mass spectrometery detection.

The apparatus may further include a mass spectrometer (MS) coupled to the plasma source, such as a time-of-flight or magnetic sector mass spectrometer. The MS is configured to receive a vertical beam of ions.

In certain aspects, the sample stage may be vertical, and is operable to run in the vertical position (e.g., controlled by a motor that can oppose the force of gravity while still providing steps on the scale of the ablation spot diameter).

In certain aspects, the plasma source may be oriented vertically. The plasma source may be vacuum sealed (e.g., with the exception of the injector inlet to the plasma source).

The plasma source may be an inductively coupled plasma torch (ICP source). For example, the apparatus may be an LA-ICP-MS system.

A method may include analyzing a sample by LA-ICP-MS using an apparatus described herein. The sample is a biological sample and may include labelling atoms (such as labelling atoms of an SBP attached to an analyte of the biological sample). The method may further include labelling the sample with labelling atoms prior to analyzing the sample by LA-ICP-MS.

Aspects of the subject application also include apparatus and methods for introduction of a hydrogen containing molecule into an ICP torch in LA-ICP-MS, e.g., for signal enhancement. The hydrogen-containing molecule may be a gas, such as hydrogen gas, ammonia or methane as described further herein. Alternatively or in addition, the hydrogen-containing molecule, such as a water or alcohol (e.g., ethanol), may be introduced to a gas flow as a vapor as described further herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 is a diagrammatic view of a laser ablation system showing the sampling of the laser ablated plume through an aperture configured for transferring the plume into an injector.

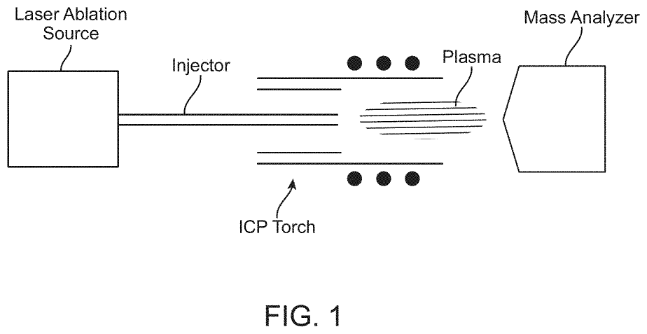

FIG. 2 is a view of sampling configurations with a horizontal plasma.

FIG. 3 is a view of sampling configurations with a vertical plasma.

FIG. 4 is a schematic of an exemplary LA-ICP-MS system of the art.

FIG. 5 is a graph of sensitivity (average counts of Lu ions per shot) as a function of humidity (microbars) of an Argon transfer gas.

FIG. 6 is an illustration of humidification systems suitable for LA-ICP-MS.

FIG. 7 is a graph of sensitivity (counts of Lu ions per shot) over a long sample run (60,000 seconds) while humidity of the Argon transfer gas is maintained.

FIG. 8 is a graph of the sensitivity (average counts Lu ions per shot) as a function of Hydrogen gas flow (L/min).

FIG. 9 is a comparison of imaging mass cytometry image signal improvements by humidification (left) or use of a 3% Hydrogen/Helium pre-mixed gas source for a capture gas (right).

### DETAILED DESCRIPTION OF VARIOUS EMBODIMENTS

It should be understood that the phrase “a” or “an” used in conjunction with the present teachings with reference to various elements encompasses “one or more” or “at least one” unless the context clearly indicates otherwise.

The term “comprising” encompasses “including” as well as “consisting” e.g. a composition “comprising” X may consist exclusively of X or may include something additional e.g. X+Y.

The term “about” in relation to a numerical value x is optional and means, for example, x±10%.

The word “substantially” does not exclude “completely” e.g. a composition which is “substantially free” from Y may be completely free from Y. Where necessary, the word “substantially” may be omitted from the definition of the invention.

The word “invention” refers to certain aspects, examples, or embodiments of the invention rather than referring to all embodiments of the invention.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. All publications and patent documents cited herein are incorporated herein by reference as if each such publication or document was specifically and individually indicated to be incorporated herein by reference. Citation of publications and patent documents (patents, published patent applications, and unpublished patent applications) is not intended as an admission that any such document is pertinent prior art, nor does it constitute any admission as to the contents or date of the same.

The present invention relates to imaging mass spectrometry, including laser ablation combined with inductively coupled plasma mass spectrometry (LA-ICP-MS). LA-ICP-MS has been described for measurement of endogenous elements in biological materials and, more recently, for imaging by detection of elemental-tagged antibodies. See, e.g., Antonov, A. and Bandura, D., 2012, U.S. Pat. Pub. 2012/0061561, incorporated by reference herein; Seuma et al., “Combination of immunohistochemistry and laser ablation ICP mass spectrometry for imaging of cancer biomarkers” 2008, Proteomics 8:3775-3784; Hutchinson et al. “Imaging and spatial distribution of 3-amyloid peptide and metal ions in Alzheimer's plaques by laser ablation-inductively coupled plasma-mass spectrometry” Analytical biochemistry 2005, 346.2:225-233; Becker et al. “Laser ablation inductively coupled plasma mass spectrometry (LA-ICP-MS) in elemental imaging of biological tissues and in proteomics.” 2007, Journal of Analytical Atomic Spectrometry 22.7:736-744; Binet, et al., “Detection and characterization of zinc- and cadmium-binding proteins in Escherichia coli by gel electrophoresis and laser ablation-inductively coupled plasma-mass spectrometry” Analytical Biochemistry 2003, 318:30-38; Quinn, et al., “Simultaneous determination of proteins using an element-tagged immunoassay coupled with ICP-MS detection Journal of Analytical Atomic Spectrometry” 2002, 17:892-96; Sharma, et al., “Sesbania drummondii cell cultures: ICP-MS determination of the accumulation of Pb and Cu Microchemical Journal” 2005, 81:163-69; and Giesen et al. “Multiplexed immunohistochemical detection of tumor markers in breast cancer tissue using laser ablation inductively coupled plasma mass spectrometry” 2011, Anal. Chem. 83:8177-8183, each of which is incorporated by reference herein. Plasma sources other than ICP are also within the scope of the subject application.

Due to the limitations of nano-positioning stages, access requirements for high NA optics and/or the desire to keep the sample in an IMC apparatus as close to the plasma as possible, there are several different plasma and sampling orientations that are considered herein and described in the below table:

| | | Sampling | Stage | Plasma | | Transient |
|---|---|---|---|---|---|---|
| Sample | Plasma | from | challenge | challenge | Redeposition | broadening |
| Horizontal | Horizontal | Above | Low | Low | Yes | Some |
| Horizontal | Horizontal | Below | Medium | Low | No | Some |
| Vertical | Horizontal | Side | Medium | Low | No | Minimal |
| Horizontal | Vertical | Above | Low | Medium | Yes | Minimal |
| Horizontal | Vertical | Below | Medium | Medium | No | Minimal |
| Vertical | Vertical | Either | Medium | Medium | No | Some |

By rotating the plasma to an optimal orientation, we can overcome some of the undesirable properties of previous configurations (which resulted in transient broadening due to 90-degree turn and long transfer length, cross-contamination due to gravity pulling large particles back onto the sample surface). Of note, vertical plasmas have been in ICP-OES machines as the orientation makes it more straightforward to image along the axis of the torch (since the cylindrical symmetry of the plasma is preserved). By comparison, the symmetry is broken in a horizontal orientation, due to the convective lift of the plasma as it exits the torch body.

In certain aspects, the torch may be a sealed torch. The sealed torch is airtight and does not communicate fluidically with air outside the torch (e.g., other than the gas sources supplying gas flows). The sealed torch may be vacuum sealed. In certain aspects, a laser ablation chamber is airtight and does not communicate fluidically with air outside the instrument. In certain aspects, the entirety of a laser ablation ICP-MS system is sealed to prevent air from passing into the torch. The gas flows and the gas dynamics in a sealed torch may dominate over convective effects. A sealed torch may behave nearly identically in any orientation (e.g., with similar ionization efficiencies for the same gas flows, sample material and induction conditions), and may be oriented in the vertical direction (e.g., pointing away from the vector of gravity or in the direction of gravity).

The transport of ablated material by gas flows presents a few challenges in our applications. Namely, turning the plume aggressively leads to transient broadening, as does excessive overall length of the gas channel between the sample and the plasma. As a result, for optimal pixel acquisition speed, we desire to have the plasma be oriented perpendicularly to the sample substrate, and to be as close as possible.

One limitation on our choice of orientation is related to the specifications of our nano-positioning stages. Stages that possess the speed and dynamic positioning precision required for our applications usually have insufficient maximum force to support the sample and associated hardware (springs, clamps etc. . . . ) against the force of gravity. This means that configurations involving a vertically-oriented sample are more challenging from an XYZ stage engineering point of view. However, such devices are relatively low-risk in terms of the engineering of the plasma, since we are already experienced in constructing mass analyzers with horizontal plasmas.

Another option is to leave the sample horizontal and direct the plasma either upwards or downwards. Each of these configurations has its own potential benefits and drawbacks.

For the upwardly-directed plasma, one benefit is that the heat from the plasma rises away from the sample and into the interface region of the mass analyzer. Since we already liquid cool the interface, this presents a small (possibly negligible) delta in the heat budget of the machine. The downside of this approach is that any ablated material that is not picked-up by the gas stream (ie: larger particles) will fall back onto the sample, causing cross-talk and contamination.

In the case of the downward-directed plasma, there is not much risk of sample contamination from larger ablated particles, as gravity will pull the particles away from the sample. However, there is a chance that the heat rising from the plasma could pose a challenge, as it will rise towards the sample. This could be overcome by including a thermal break between the sample and the plasma containment, but this comes at the cost of potentially lengthening the gas path between the sample and the plasma, resulting in transient broadening. There is also a chance that convective forces will result in extra transient broadening in such a plasma.

In principle, the ablation light can be incident from either side of the sample. However, there are several trade-offs to consider.

If the ablation light is incident from the same side as the sample transport/plasma a compromise must be struck between optical access and sample transport access to the ablation spot, and may result in one or more of the below trade-offs.
The focusing optics will increase the minimum sample transfer distance significantly.
The focusing optics will be more difficult to manufacture and assemble.
The maximum attainable throughput will be lower.
Any optical inspection of the sample area will be compromised in terms of field of view, resolution, illumination uniformity, etc.
The instrument will be less modular.

On the other hand, ablation light incident from the opposite side of the sample transport/plasma may result in one or more of the below trade-offs.
The ablation light must pass through the sample substrate, which means quartz microscope slides must be used for UV laser ablation, or another substrate such as silica that is at least partially transparent to UV light.
The optical inspection of the sample area may be compromised by light from the plasma if the sample transport is straight-through.
The sample holder and stage assembly must provide a clear aperture for the ablation/inspection optics, leading to a more expensive/more complex assembly.

In certain aspects, the laser ablation may be non-UV laser ablation (e.g., may be in the visible or IR spectrum, such as green laser ablation source). The non-UV laser may have properties such as frequency and/or power similar to UV laser ablation sources described herein. This may allow the laser radiation to pass through a glass slide (which is commonly used for microscopy). However, biological samples such as a tissue section, cell smear, or cell culture, may ablate better in the UV spectrum than in a visible (e.g., green) or IR spectrum.

In certain aspects, the sample may be treated (e.g., after staining with mass tagged SBPs) with a compound that assists with laser ablation (e.g., that lowers the laser ablation threshold). The compound may be a dye that absorbs at the wavelength of laser ablation, such as a non-UV wavelength (e.g., green or IR). The compound may distribute non-specifically throughout the sample.

In certain aspects, opposite slide ablation may be used to ablate a layer underneath the sample to lift a portion of the sample off the slide, such as is described by US Patent Publication No. 20160194590, which is hereby incorporated by reference. In certain aspects, compounds for transferring kinetic energy to the sample (e.g., that transition to a gaseous state under ablation) may be embedded in the sample itself.

As described herein, the laser may be a femtosecond (fs) laser. For example, a fs laser in the near-IR range may be operated at the 2nd harmonic to provide laser radiation in the green range, or at the 3rd harmonic to provide laser radiation in the UV range. A lower wavelength such as a green or UV may allow for higher resolution (e.g., smaller spot size). When the laser radiation travels across a sample support to impinge on the sample, the sample support needs to be transparent to the laser radiation. Glass and silica are transparent to green wavelength, which silica but not glass are transparent to UV. To enable high resolution while allowing for use of a glass slide, an IR fs laser may be operated at the 2nd harmonic (e.g., around 50% conversion efficiency) to provide green laser radiation. Of note commercially available objectives often have the best correction in the green range. The resolution achieved by a green or UV fs laser may be at a spot size at or less than 1 um, 800 nm, 500 nm, 400 nm, 300 nm, 200 nm, 150 nm, or 100 nm.

For instance, the frequency of ablation by the laser system is within the range 200 Hz-100 MHz, 200 Hz-10 MHz, 200 Hz-1 MHz, 200 Hz-100 kHz, within the range 500-50 kHz, or within the range 1 kHz-10 kHz. The ablation frequency of the laser should be matched to the scanning rate of the laser scanning system as discussed above.

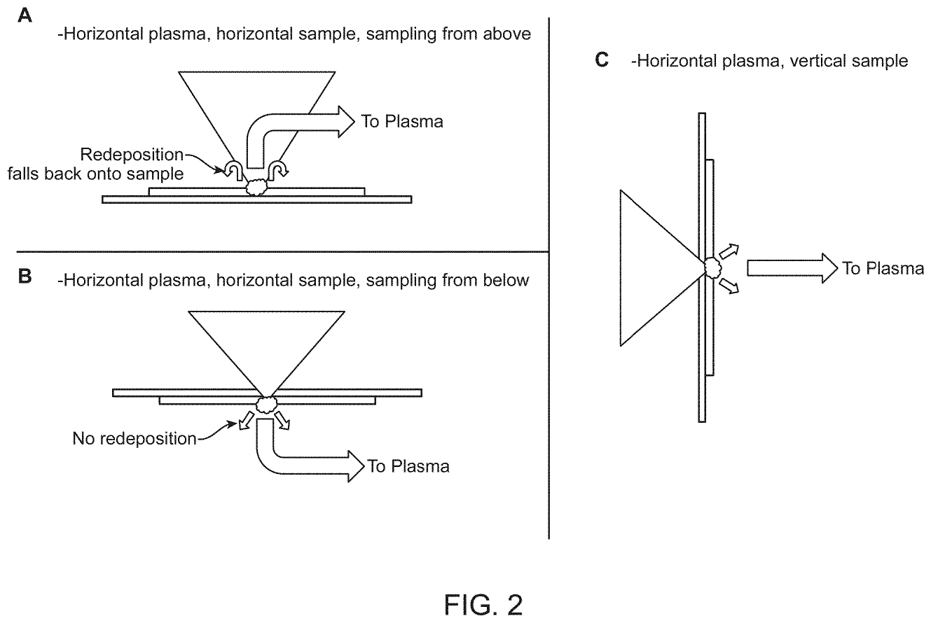

FIG. 2 shows a number of configurations in which the plasma (e.g., ICP) is horizontal. Laser radiation is depicted as a shaded triangle. The sample is depicted as mounted on a wider sample stage.

FIG. 2A shows a horizontal stage with injection into a horizontal plasma, as has been done previously. FIG. 2A shows a horizontal sample with sampling from above—the sample, held on a horizontally-oriented slide (also described as a coverslip or substrate), is ablated (either from above, or through the substrate from below) and the plume is directed upwards. The plume is captured in a gas flow and turned orthogonally to enter the horizontal plasma. This may lead to redeposition due to the force of gravity.

FIG. 2B shows a configuration with sampling from below—the plume is directed downwards from the horizontal substrate by ablation from below, or by ablation through the substrate from above. The plume is captured by a gas flow and turned orthogonally to enter the horizontal plasma. Redeposition (e.g., due to gravity) may not occur in this configuration.

FIG. 2C shows a vertical sample. The light for ablation can be directed either through the substrate (from behind) or from the sample side. The plume is directed horizontally, and is captured and transferred directly into the plasma by a gas flow without needing to be turned.

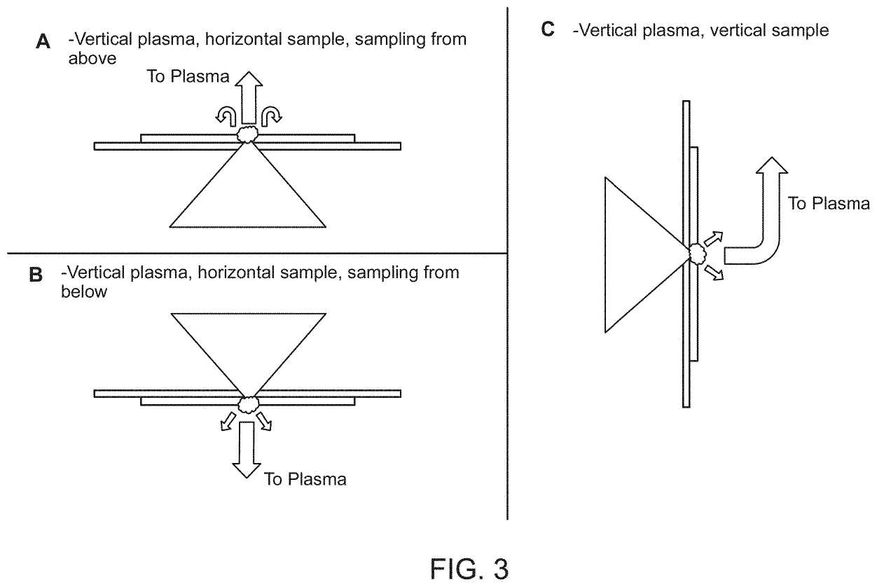

FIG. 3 is similar to FIG. 2 but shows a number of configurations in which the plasma (e.g., ICP) is vertical.

FIG. 3A shows a horizontal sample with sampling from above—the plasma is positioned above the sample, and the gas flow is directed upwards. The ablation light is directed either from above or below the sample, and the plume is projected upwards. The plume is captured and transferred to the plasma by a gas flow.

FIG. 3B shows a horizontal sample with sampling from below—here, the gas flow towards the plasma is directed downwards and hence the plasma is positioned below the sample. Ablation light is applied from either above or below, and the ablated plume, which leaves the sample projected downwards, is captured by a gas flow and transferred directly into the plasma.

FIG. 3C shows a vertical sample with sampling from the side (e.g., through the sample). The plume leaves the surface of the substrate and is captured by a gas flow before being turned 90-degrees to enter the plasma, which may be directed either upwards or downwards.

Apparatus of the subject applications may include one or more components described below.

Aspects include methods and systems for laser ablation mass cytometry analysis in which pulses of a laser beam are directed to a sample for generating a plume of sample for each of the pulses; capturing each plume distinctively for each of the pulses; transferring each of the distinctively captured plume to an ionization system; and ionizing each of the distinctively captured and transferred plumes in the ionization system and generating ions for mass analysis and apparatus for carrying out the method. In various embodiments, the apparatus has a laser ablation system for generating an ablated plume from a sample and a transfer conduit adapted to couple the laser ablation system with the ionization system of the apparatus. In some embodiments the transfer conduit can have an inlet positioned within the laser ablation system such that the inlet can be configured for capturing the ablated plume as the ablated plume is generated. A gas inlet can be coupled to the inlet of the transfer conduit for passing a gas there between for transferring the captured ablated plume into the ionization system. Where the ionization system is an ICP, the transfer conduit may be called an injector, if the output of the conduit is directly within the plasma of the ICP. The laser ablation system, ionization system, and mass spectrometer components are discussed in more detail individually below. As noted above, the focus of the present invention is modifications to the transfer conduit which connects the laser ablation system to the ionization system.

Transfer Conduit

The transfer conduit forms a link between the laser ablation system and the ionization system, and allows the transportation of plumes of sample material, generated by the laser ablation system, from the laser ablation system to the ionization system. Part (or all) of the transfer conduit may be formed, for example, by drilling through a suitable material to produce a lumen (e.g., a lumen with a circular, rectangular or other cross-section) for transit of the plume. The transfer conduit sometimes has an inner diameter in the range 0.2 mm to 3 mm. In some embodiments, the internal diameter of the transfer conduit varies along its length. For example, the transfer conduit may be tapered at an end. A transfer conduit sometimes has a length in the range of 1 centimeter to 100 centimeters. In some embodiments the length is no more than 10 centimeters (e.g., 1-10 centimeters), no more than 5 centimeters (e.g., 1-5 centimeters), or no more than 3 cm (e.g., 0.1-3 centimeters). In some embodiments the transfer conduit lumen is straight along the entire distance, or nearly the entire distance, from the ablation system to the ionization system. In some embodiments the transfer conduit lumen is not straight for the entire distance and changes orientation. For example, the transfer conduit may make a gradual 90 degree turn. This configuration allows for the plume generated by ablation of a sample in the laser ablation system to move in a vertical plane initially while the axis at the transfer conduit inlet will be pointing straight up, and move horizontally as it approaches the ionization system (e.g. an ICP torch which is commonly oriented horizontally to take advantage of convectional cooling). In some embodiments the transfer conduit is straight for a distance of least 0.1 centimeters, at least 0.5 centimeters or at least 1 centimeter from the inlet aperture though which the plume enters or is formed. In some embodiments, the transfer conduit is adapted to minimize the time it takes to transfer material from the laser ablation system to the ionization system.

An injector of the apparatus may include a transfer conduit described herein.

Sample Cone Inlets

The transfer conduit comprises an inlet in the laser ablation system, which receives sample material ablated from a sample in the laser ablation system, and transfers it to the ionization system. In some instances, the laser ablation system inlet is the source of all gas flow along the transfer conduit to the ionization system. In some instances, the laser ablation system inlet that receives material from the laser ablation system is an aperture in the wall of a conduit along which a second “transfer” gas is flowed (as disclosed, for example in WO2014146724 and WO2014147260) from a separate transfer flow inlet. In this instance, the transfer gas forms a significant proportion, and in many instances the majority of the gas flow to the ionization system. The component comprising the transfer flow inlet, laser ablation system inlet and which begins the transfer conduit which carries the ablated sample material towards the ionization system can also termed a flow cell (as it is in WO2014146724 and WO2014147260).

The transfer flow fulfills at least three tasks: it flushes the plume entering the transfer conduit in the direction of the ionization system, and prevents the plume material from contacting the side walls of the transfer conduit; it forms a “protection region” above the sample surface and ensures that the ablation plume is carried out under a controlled atmosphere; and it increases the flow speed in the transfer conduit. In some embodiments the viscosity of the capture gas is lower than the viscosity of the primary transfer gas. This helps to confine the plume of sample material in the capture gas in the center of the transfer conduit and to minimize the diffusion of the plume of sample material downstream of the laser ablation system (because in the center of the flow, the transport rate is more constant and nearly flat). The gas(es) may be, for example, and without limitation, argon, xenon, helium, nitrogen, or mixtures of these. In some embodiments, the transfer gas is argon. Argon is particularly well-suited for stopping the diffusion of the plume before it reaches the walls of the transfer conduit (and it also assists improved instrumental sensitivity in apparatus where the ionization system is an argon gas-based ICP). The capture gas is preferably helium. However, the capture gas may be replaced by or contain other gases, e.g., hydrogen, nitrogen, or water vapor. At 25° C., the kinematic viscosity (dynamic viscosity/density) for Argon is around 1.3E⁻⁵ m²/s, while Helium is around 1.2E⁴ m²/s. As such, the difference in kinetic viscosity values for Argon and Helium may be at least 5 fold, or at least 10 fold. In some embodiments the capture gas is helium and the transfer gas is helium.

The use of a sample cone may minimize the distance between the target and the conduit comprising the transfer flow of gas. Because of the reduced distance through which the capture gas flows at the point of the cone, this also leads to improved capture of sample material with less turbulence, and so reduced spreading of the plumes of ablated sample material. The inlet of the transfer conduit is therefore the aperture at the tip of the sample cone. The cone projects into the ablation chamber.

A further kind of asymmetry is a cone formed from two elliptical halves, which share a common height (z) and one base diameter (the x diameter), but which differ in the other base (the y diameter) (or one elliptical and one circular half).

All of the above adaptations may be present in a single asymmetric sample cone as use in the invention. For example, the cone may be asymmetrically truncated and formed from two different elliptical cone halves, the cone may be asymmetrically truncated and comprise one of more orifices and so on.

The sample cone is therefore adapted to capture all or part of a plume of material ablated from a sample in the laser ablation system. The sample cone is positioned operably proximate to the sample, e.g. by maneuvering the sample within the laser ablation system on a movable sample carrier tray, as described in more detail below. As noted above, plumes of ablated sample material enter the transfer conduit through an aperture at the narrow end of the sample cone. In some embodiments, the diameter of the aperture a) is adjustable; b) is sized to prevent perturbation to the ablated plume as it passes into the transfer conduit; and/or c) is about the equal to the cross-sectional diameter of the ablated plume. In some embodiments, the diameter of the aperture is between about 100 μm to 1 mm. For example, the diameter of the aperture is between about 200 μm to 900 μm, such as 300 μm to 800 μm. In some embodiments, the diameter of the aperture is between about 500 μm to 700 μm. In some embodiments, the diameter of the aperture is about 500 μm. In some embodiments, the diameter of the aperture is about 700 μm.

Tapered Conduits

In tubes with a smaller internal diameter, the same flow rate of gas moves at a higher speed. Accordingly, by using a tube with a smaller internal diameter, a plume of ablated sample material carried in the gas flow can be transported across a defined distance more rapidly at a given flow rate (e.g. from the laser ablation system to the ionization system in the transfer conduit). One of the key factors in how quickly an individual plume can be analyzed is how much the plume has diffused during the time from its generation by ablation through to the time its component ions are detected as the mass spectrometer component of the apparatus (the transience time at the detector). Accordingly, by using a narrow transfer conduit, the time between ablation and detection is reduced, thereby meaning diffusion is decreased because there is less time in which it can occur, with the ultimate result that the transience time of each ablation plume at the detector is reduced. Lower transience times mean that more plumes can be generated and analyzed per unit time, thus producing images of higher quality and/or faster.

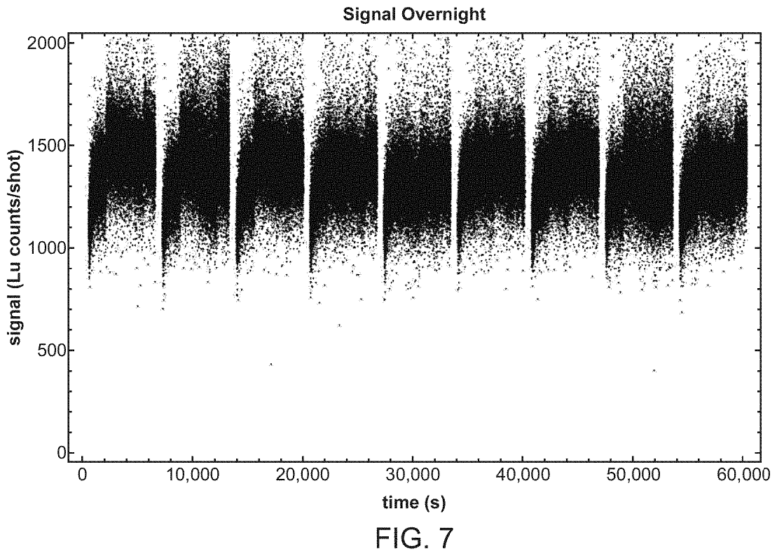

The taper may comprise a gradual change in the internal diameter of the transfer conduit along said portion of the length of the transfer conduit (i.e. the internal diameter of the tube were a cross section taken through it decreases along the portion from the end of the portion towards the inlet (at the laser ablation system end) to the outlet (at the ionization system end). As shown in FIGS. 3B and 7C, the tapering modification to the transfer conduit is applicable to all embodiments of the apparatus described herein, whether they comprise a direct injector inlet, a sample cone, or any other structure at the ionization system inlet end of the transfer conduit. The larger volume of the conduit before the taper facilitates the confinement of the materials generated by ablation. When the ablated particles fly off from the ablated spot they travel at high velocities. The friction in the gas slows these particles down but the plume can still spread on a sub-millimeter to a millimeter scale. Allowing for sufficient distances to the walls helps with the containment of the plume near the center of the flow.

Because the wide internal diameter section is only short (of the order of 1-2 mm), it does not contribute significantly to the overall transience time providing the plume spends more time in the longer portion of the transfer conduit with a narrower internal diameter. Thus, a larger internal diameter portion is used to capture the ablation product, keeping it confined near the central streamline where the gas flow velocity is more uniform, and a smaller internal diameter conduit is used to transport these particles rapidly to the ionization system. The plume will expand a certain amount, at least partly determined by the particle size and choice of gas. The initial portion of the injector tube may be sized such that the majority of the plume will fall near the central streamlines such that the plume is not broadened by the effect of the development of the parabolic flow profile. The injector may comprise a taper that narrows the diameter of the injector tube after the initial portion, e.g., to improve transfer speed.

In some embodiments, the taper begins within 50 mm of the ionization system inlet to the transfer conduit. In some embodiments, the taper begins within 40 mm of the ionization system inlet, such as within 30 mm, within 20 mm, within 15 mm, or within 10 mm of the ionization system inlet. In some embodiments, the taper begins within 5 mm, within 4 mm, within 3 mm, within 2 mm or within 1 mm downstream of the ionization system inlet. In some embodiments, the taper begins 1-2 mm downstream of the ionization system inlet.

The taper between the large internal diameter portion and the small internal diameter region can be made sufficiently gentle to avoid the onset of the turbulence. For example, the taper can be at an angle of at least 5 degrees. In some embodiments, the angle of the taper can be at least 10 degrees, such as at least 15 degrees, at least 20 degrees, at least 25 degrees, or 30 degrees or more, even such as 60 degrees. In some embodiments, the taper is at an angle less than 40 degrees, such as less than 30 degrees, less than 25 degrees, less than 20 degrees, less than 15 degrees, or less than 10 degrees. In some embodiments, the taper is at an angle less than 8 degrees, such as less than 5 degrees, less than 4 degrees, less than 3 degrees, less than 2 degrees, or less than 1 degree. In some embodiments, the angle of the taper is between 10 and 30 degrees. In some embodiments, the angle of the taper may increase or decrease along the length of the taper.

In some embodiments, the length of the taper is at least 5 mm, for example at least 10 mm, at least 20 mm, at least 30 mm, at least 40 mm or at least 50 mm or at least 100 mm. In some embodiments, the length of the taper is less than 10 mm, for example, less than 5 mm, less than 4 mm, less than 3 mm, less than 2 mm or 1 mm or less.

The transfer conduit internal diameter can be x millimeters (mm) at the input end of the conduit but it can be tapered down 5-fold to x/5 mm near the output end (e.g. 4 mm at the input end and 800 μm at the output end). In some embodiments, the taper reduces the internal diameter of the transfer conduit by less than 5-fold, such as 4-fold or less, 3-fold or less, or 2-fold or less. The internal diameter is the measure of the longest cross-section through the conduit. E.g. if the conduit is circular, the internal diameter is simply the diameter of the circle, but if the conduit is a rectangle, it is the diagonal. In some embodiments, the internal diameter of the conduit following the taper is narrower than 2 mm, for example narrower than 1.5 mm, narrower than 1.25 mm, narrower than 1 mm, narrower than 900 μm, narrower than 800 μm, narrower than 700 μm, narrower than 600 μm, or 500 μm or narrower. In some embodiments, the internal diameter of the conduit following the taper is 400 μm or narrower, 300 μm or narrower, 200 μm or narrower or 100 μm or narrower.

The diameter of the narrow internal diameter section is limited by the diameter corresponding to the onset of turbulence. A Reynolds number can be calculated for a round tube and a known flow. In general a Reynolds number above 4000 will indicate a turbulent flow, and thus should be avoided. A Reynolds number above 2000 will indicate a transitional flow (between non-turbulent and turbulent flow), and thus may also be desired to be avoided. For a given mass flow of gas the Reynolds number is inversely proportional to the diameter of the conduit. Accordingly, in some embodiments, the internal diameter of the narrow internal diameter section of the transfer conduit is narrower than 2 mm, for example narrower than 1.5 mm, narrower than 1.25 mm, narrower than 1 mm, but greater than the diameter at which a flow of helium at 4 liters per minute in the conduit has a Reynolds number greater than 4000.

Rough or even angular edges in the transitions between the constant diameter portions of the transfer conduit and the taper may cause turbulence in the gas flow. Accordingly, in some embodiments, the transitions into and from the taper should have smooth edges adapted to suppress the onset of turbulence. For instance, the edges may be rounded and or chamfered.

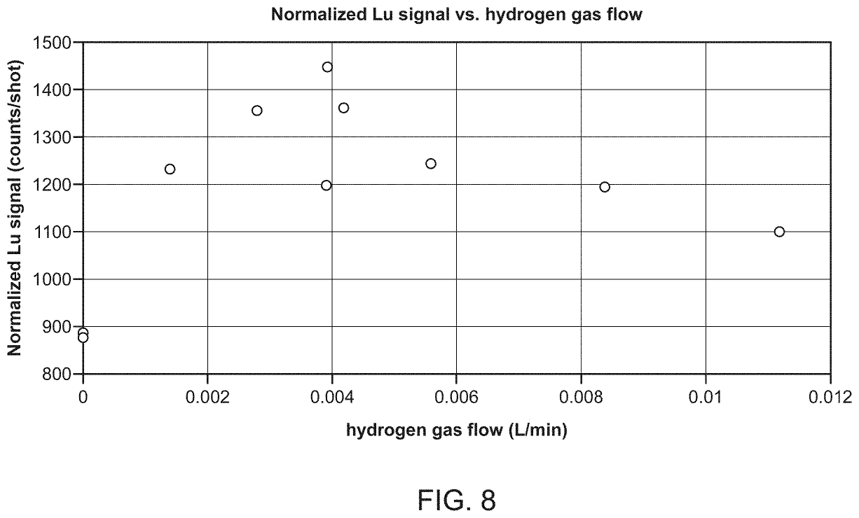

Apparatus comprising a tapered conduit can also comprise a sample cone (optionally asymmetric). As would be understood by the skilled person, the tapered conduit can be employed in any of the apparatus described herein which use alternative transfer conduit arrangements, as illustrated e.g. in FIGS. 2-10, and as discussed herein in detail in the following sections.

Sacrificial Flow

At higher flows, the risk of turbulence occurring in the conduit increases. This is particularly the case where the transfer conduit has a small internal diameter (e.g. 1 mm, or less than 1 mm). The inventor has discovered, however, that it is possible to achieve high speed transfer (up to and in excess of 300 m/s) in transfer conduits with a small internal diameter if a light gas, such as helium or hydrogen, is used instead of argon, which is traditionally used as the transfer flow of gas. In certain embodiments, a mixture of gas primarily comprising helium or hydrogen is used.

High speed transfer presents problems insofar as it may cause the plumes of ablated sample material to be passed through the ionization system without an acceptable level of ionization occurring. The level of ionization can drop because the increased flow of cool gas reduces the temperature of the plasma at the end of the torch. If a plume of sample material is not ionized to a suitable level, information is lost from the ablated sample material—because its components (including any labelling atoms/elemental tags) cannot be detected by the mass spectrometer. For example, the sample may pass so quickly through the plasma at the end of the torch in an ICP ionization system that the plasma ions do not have sufficient time to act on the sample material to ionize it. The inventor has discovered that this problem, caused by high flow, high speed transfer in narrow internal diameter transfer conduits can be solved by the introduction of a flow sacrificing system at the outlet of the transfer conduit. The flow sacrificing system is adapted to receive the flow of gas from the transfer conduit, and pass only a portion of that flow (the central portion of the flow comprising any plumes of ablated sample material) onwards into the injector that leads to the ionization system. To facilitate dispersion of gas from the transfer conduit in the flow sacrificing system, the transfer conduit outlet can be flared out.

The flow sacrificing system is positioned close to the ionization system, so that the length of the tube (e.g. injector) that leads from the flow sacrificing system to the ionization system is short (e.g. ^{˜}1 cm long; compared to the length of the transfer conduit which is usually of a length of the order of tens of cm, such as ^{˜}50 cm). Thus the lower gas velocity within the tube leading from the flow sacrificing system to the ionization system does not significantly affect the total transfer time, as the relatively slower portion of the overall transport system is much shorter.

Accordingly, the invention provides an apparatus comprising:

(i) a laser ablation system, adapted to generate plumes of sample material from a sample;

(ii) an ionization system that is adapted to receive material removed from the sample by the laser ablation system and to ionize said material to form elemental ions;

(iii) a mass spectrometer to receive elemental ions from said ionization system and to analyze said elemental ions,

wherein the laser ablation system and the ionization system are coupled together by a transfer conduit and a flow sacrificing system,

wherein the transfer conduit is adapted to carry a flow of gas containing plumes of ablated sample material from an inlet in the laser ablation system to an outlet in the flow sacrificing system, wherein the flow sacrificing system comprises a chamber comprising:

(a) the outlet of the transfer conduit;

(b) an ionization system inlet, positioned to receive sample material from the transfer conduit outlet and to introduce the sample material into the ionization system; and

(c) a sacrificial flow outlet,

wherein the flow sacrificing system is adapted to reduce the flow of gas entering the ionization system through the ionization system inlet compared to the flow of gas entering the flow sacrificing system through the transfer conduit, by directing some of the flow of gas entering the flow sacrificing system out of the sacrificial flow outlet, and

wherein the outlet of the transfer conduit in the flow sacrificing system is optionally flared.

In some embodiments, the ionization system inlet is positioned co-axially to the outlet of the transfer conduit (because the plumes of sample material being transferred along the conduit will be entrained within the center of the transfer flow), to maximize transmission of material from the transfer conduit, through the flow sacrificing system, to the ionization system inlet, and so to the injector of the ionization system. In some embodiments, the ratio of the internal diameter of the transfer conduit to the internal diameter of the inlet of the ionization system is less than 2:1, for example 1.5:1 or 1:1. In some embodiments, the ratio of the internal diameter of the transfer conduit to the internal diameter of the injector of the ionization system is less than 2:1, for example 1.5:1 or 1:1. In some embodiments, the internal diameter of the injector of the ionization system (or the inlet to the ionization system) has a greater internal diameter than the transfer conduit. For example, in some embodiments, the ratio of the internal diameter of the transfer conduit to the internal diameter of the inlet of the ionization system is less than 1:1, for example 1:1.5 or 1:2. In some embodiments, the ratio of the internal diameter of the transfer conduit to the internal diameter of the injector of the ionization system is less than 1:1, for example 1:1.5 or 1:2.

In most arrangements, it is not desirable, or in some cases possible, to significantly increase the diameter of the tube (e.g. the injector) which passes from the flow sacrificing system to the ionization system as a way of reducing the speed of the gas at a volumetric flow rate. For example, where the ionization system is an ICP, the conduit from the flow sacrificing system forms the injector tube in the center of the ICP torch. When a wider internal diameter injector is used, there is a reduction in signal quality, because the plumes of ablated sample material cannot be injected so precisely into the center of the plasma (which is the most efficiently ionizing part of the plasma). The strong preference is for injectors of 1 mm internal diameter, or even narrower (e.g. an internal diameter of 800 μm or less, such as 600 μm or less, 500 μm or less or 400 μm or less). Other ionization techniques rely on the material to be ionized within a relatively small volume in three dimensional space (because the necessary energy density for ionization can only be achieved in a small volume), and so a conduit with a wider internal diameter means that much of the sample material passing through the conduit is outside of the zone in which energy density is sufficient to ionize the sample material. Thus narrow diameter tubes from the flow sacrificing system into the ionization system are also employed in apparatus with non-ICP ionization systems. As noted above, if a plume of sample material is not ionized to a suitable level, information is lost from the ablated sample material—because its components (including any labelling atoms/elemental tags) cannot be detected by the mass spectrometer.

Rough or even angular edges in the transition between the constant diameter portion of the transfer conduit and the flare at the outlet may cause turbulence in the gas flow. Accordingly, in some embodiments, the transition into the flare out should have smooth edges adapted to suppress the onset of turbulence. For example, the edges may be rounded.

Pumping can be used to help ensure a desired split ratio between the sacrificial flow and the flow passing into the inlet of the ionization system. Accordingly, in some embodiments, the flow sacrificing system comprises a pump attached to the sacrificial flow outlet. A controlled restrictor can be added to the pump to control the sacrificial flow. Therefore, in some embodiments, the pump of the flow sacrificing system further comprises a restrictor adapted to control the flow of gas through the sacrificial flow outlet. In some embodiments, the flow sacrificing system comprises a mass flow controller, adapted to control the restrictor.

Where expensive gases are used, the gas pumped out of the sacrificial flow outlet can be cleaned up and recycled back into the same system using known methods of gas purification. Helium is particularly suited as a transport gas as noted above, but it is expensive; thus, it is advantageous to reduce the loss of helium in the system (i.e. when it is passed into the ionization system and ionized). The flow sacrificing system splits the helium flow into a near-axial flow and a sacrificial flow. The sacrificial flow can be cleaned up and recycled in the system while the near-axial flow (the central portion of the flow that carries the entrained particles from the ablated plume) will be passed into the ionization system (e.g. the plasma of an ICP torch). The helium from the near-axial flow will be lost for recovery. Accordingly, in some embodiments a gas purification system is connected to the sacrificial flow outlet of the flow sacrificing system. In some embodiments, the gas purification system provides a portion of the gas flowed into the apparatus, for example through an inlet into the laser ablation system's ablation chamber and/or through an inlet in the transfer conduit.

As before, a larger transfer flow rate is sent down the transfer conduit and only the central portion of this flow is allowed to become the part of the injector flow that will enter the plasma of the ICP torch. Typically, helium gas will be used as a transfer flow, because as noted above its properties are well suited for high velocity transport of the plume material over a long conduit (i.e. less chance to trigger the turbulence for the same flow velocity (as compared to argon). Even incorporating a gas purification system that recycles helium from the sacrificial flow, the near-axial flow of helium that continues through the flow sacrificing system into the ionization system is lost.

Accordingly, in some embodiments, the flow sacrificing system is adapted to reduce the flow of gas passing into the ionization system inlet (e.g. the injector of an ICP torch ionization system) to below 1 Lpm, such as 0.5 Lpm or less, 0.4 Lpm or less, 0.3 Lpm or less, or 0.2 Lpm or less. In some embodiments, the ICP injector comprises a second inlet into which gas can be flowed to make up the flow rate in the injector. In some embodiments, the second inlet comprises a concentric tube around the injector attached to the ionization system inlet that introduces the make-up gas as a sheath flow around the sample-containing gas flow from the flow sacrificing system. This make up flow inlet is different from the flow of argon gas also provided in the middle and outer concentric tubes which support the plasma. This injector can also be termed a dual concentric injector.

Apparatus comprising a flow sacrificing system can also comprise a sample cone (optionally asymmetric) or a tapered conduit, as described above. In some embodiments, the apparatus comprise a flow sacrificing system, a sample cone (optionally asymmetric) and a tapered conduit, as described above. As would be understood by the skilled person, the flow sacrificing system can be employed in any of the apparatus described herein which use alternative transfer conduit arrangements.

Laser Ablation System

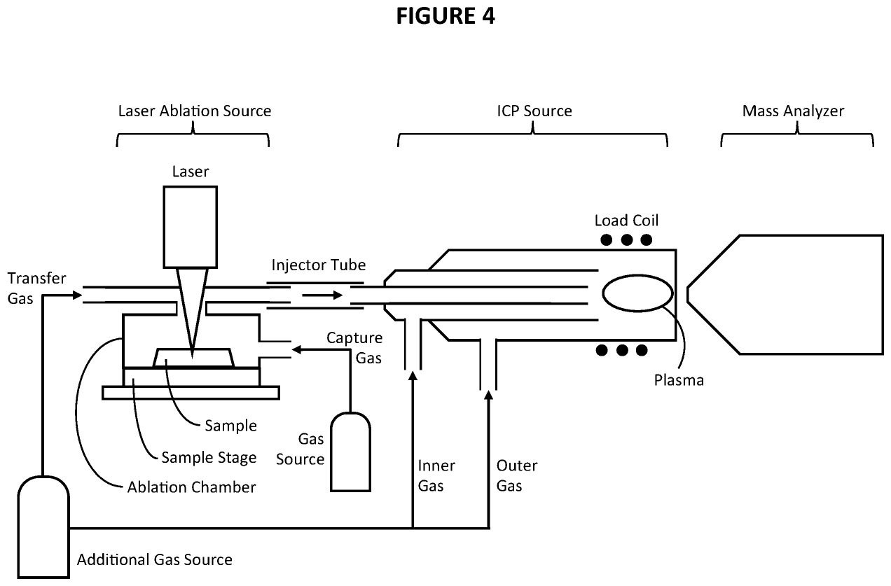

The laser ablation system, also referred to as the “ablation cell” or “laser ablation source”, houses the sample during ablation. Typically the ablation cell includes a laser transparent window to allow laser energy to strike the sample. Optionally the ablation cell includes a stage to hold the sample to be analyzed. In some embodiments the stage is movable in the x-y or x-y-z dimensions. In drawings and examples herein, the laser ablation system is sometimes shown as an open arrangement. However, such configurations are for illustration only, and it will be recognized that some form of suitable enclosure for preventing contamination or infiltration from the ambient environment is present. For example, a chamber configured with gas inlets and/or optical ports can be arranged around the laser ablation system to provide an enclosed environment suitable for capturing and transferring the ablated plume for mass analysis. The gas inlets and optical port(s) are positioned so that the orientation of the laser beam, sample, plume expansion, and transfer conduit are suitable for the methods and devices disclosed herein. It will be appreciated that the ablation cell is generally gas tight (except for designed exits and ports). Even if the ablation chamber comprises air prior to operation, it may be sufficiently enclosed from the environment such that the flow of gas (e.g., capture gas through a sample chamber and/or transfer gas into an injector tube of the ablation cell) may be sufficient to reduce contamination from air during a sample run. However, the initial presence of air may provide a level of humidity that affects sensitivity and/or signal drift. A laser ablation system of the subject application may have gas flow shown in one or more of FIG. 2, FIG. 3 or FIG. 4.

Lasers used for laser ablation according to the invention generally fall into three categories: femtosecond pulsed lasers, deep UV pulsed lasers and pulsed lasers with a wavelength chosen for high absorption in the ablated material (“wavelength selective lasers”). Deep UV and wavelength specific lasers would likely operate with nanosecond or picosecond pulses. Each class of lasers has its drawbacks and benefits and can be chosen based on a particular application. In some embodiments, the laser is a femtosecond pulsed laser configured to operate with a pulse rate between 10 and 10000 Hz. Femtosecond laser are known (see, e.g., Jhanis et al., “Rapid bulk analysis using femtosecond laser ablation inductively coupled plasma time-of-flight mass spectrometry” J. Anal. At. Spectrom., 2012, 27:1405-1412.

Femtosecond lasers allow for laser ablation of virtually all materials with the only prerequisite for laser ablation being-sufficient power density. This can be achieved even with relatively low pulse energy when the beam is tightly focused, for instance to 1 micrometer diameter and is short in duration (focused in time). Deep UV lasers also can ablate a large class of materials because most of the commonly used materials absorb deep UV photons. Wavelength selective laser ablation can utilize the lasers with the specific laser wavelength targeting absorption in the substrate material. A benefit of the wavelength specific laser may be the cost and simplicity of the laser and the optical system, albeit with a more limited spectrum of substrate materials. Suitable lasers can have different operating principles such as, for example, solid state (for instance a Nd:YAG laser), excimer lasers, fiber lasers, and OPO lasers.

A useful property of the femtosecond laser radiation is that it is absorbed only where the threshold power density is reached. Thus, a converging femtosecond laser radiation can pass through a thicker section of material without being absorbed or causing any damage and yet ablate the same material right at the surface where the focus is occurring. The focus can then be moved inside the material progressively as the sample layers are ablated. Nanosecond laser pulses might be partially absorbed by the substrate but can still work for ablation since the energy density at the focal point will be the highest (as long as it is sufficient for ablation).

The spatial resolution of signals generated in this way depends on two main factors: (i) the spot size of the laser, as signal is integrated over the total area which is ablated; and (ii) the speed at which a plume can be analyzed, relative to the speed at which plumes are being generated, to avoid overlap of signal from consecutive plumes, as discussed above. The distance referred to as spot size corresponds to the longest internal dimension of the beam, e.g. for a circular beam it is a beam of diameter 2 μm, and for a square beam corresponds to the length of the diagonal between opposed corners). The laser pulse may be shaped using an aperture, homogenized (if required) using a beam homogenizer, focused, e.g., using an objective lens, to produce a desired spot size. Typically, the spot size is 100 μm or less, such as 50 μm or less, 25 μm or less, 20 μm or less, 15 μm or less, or 10 μm or less than 10 μm. Exemplary spot sizes include diameters (or equivalent sized ablation areas of other shapes) in the range of 0.10-3 μm (e.g., about 0.3 μm), 1-5 μm (e.g., about 3 μm), 1-10 μm (e.g., about 1, about 2, about 3, about 4 or about 5 μm), less than 10 μm, and less than 5 μm. In particular embodiments, a laser system is configured to operate with sufficiently focused laser pulses to ablate a sample area in the order of about 1 μm, e.g., 100 nm to 1 μm.

In order to analyze individual cells the laser in the laser ablation system has a spot size which is no larger than these cells. This size will depend on the particular cells in a sample, but in general the laser spot will therefore have a diameter of less than 4 μm e.g. within the range 0.1-4 μm, 0.25-3 μm, or 0.4-2 μm. Thus, a laser spot can have a diameter of about 3 μm or less, about 2 μm or less, about 1 μm or less, about 0.5 μm or less than 0.5 μm, such as around 400 nm or less, around 300 nm or less, around 200 nm or less, around 100 nm or less than 100 nm. In order to analyze cells at a subcellular resolution the invention uses a laser spot size which is no larger than these cells, and more specifically uses a laser spot size which can ablate material with a subcellular resolution. Sometimes, single cell analysis can be performed using a spot size larger than the size of the cell, for example where cells are spread out on the slide, with space between the cells. Here, a larger spot size can be used and single cell characterization achieved, because the additional ablated area around the cell of interest does not comprise additional cells. The particular spot size used can therefore be selected appropriately dependent upon the size of the cells being analyzed. In biological samples, the cells will rarely all be of the same size, and so if subcellular resolution imaging is desired, the ablation spot size should be smaller than the smallest cell, if constant spot size is maintained throughout the ablation procedure. Small spot sizes can be achieved using demagnification of wider laser beams and near-field optics. A laser spot diameter of 1 μm corresponds to a laser focus point (i.e. the diameter of the laser beam at the focal point of the beam) of 1 μm, but the laser focus point can vary by ±20% or more due to spatial distribution of energy on the target (for instance, Gaussian beam shape) and variation in total laser energy with respect to the ablation threshold energy. For example, using a 25 μm diameter laser beam, and subjecting this to 25-fold demagnification onto the tissue samples will give a spot size with a 1 μm diameter.

Ablation on this small scale produces very small amount of plume material that in turn ensures that the size of the plume is kept small. A smaller plume is more likely to stay in the middle of the capture flow without contacting the walls of the ablation cell or of the transfer conduit. Ablation on the 1 micrometer scale also means that the distance between the ablated surface and the area where plume expansion slows down and becomes dominated by the ambient gas is very short. This distance can range from a few micrometers to a few hundred micrometers. In some versions of the invention, the capture flow is present where the plume stops expanding. Therefore, for illustration and not limitation, several of the appended figures show the distance between the ablated surface and the region with capture flow shown as about 100 micrometers.

Although ablation on the 1 micrometer (or lower) scale is advantageous for certain applications (e.g., imaging), the methods and instruments of the invention are also useful when larger ablation spots are produced, such as ablation spots in the range of about 5 to about 35 microns diameter, for example in the range 5-15 microns, 10-20 microns, 15-25 microns, 20-30 microns and 25-35 microns. In some applications in which large ablation spots are produced, only a portion of the plume material is captured.

In some embodiments, the laser is situated outside the ablation chamber, and the laser beam (laser energy) enters the ablation chamber, e.g., though an optical window. As used herein, a laser beam may be described as being emitted from a surface (e.g., a laser lens or mirror), which surface may be oriented to direct the beam to a particular location or pattern of locations. For ease of description of the invention, the directed beam may be considered to have a particular orientation; the orientation of the beam can refer to an imaginary line aligned with the beam and extending beyond the actual beam (for example when the beam strikes a non-transparent surface). As will be apparent from context, reference to the orientation or position of a laser beam sometimes refers to the orientation or position the beam of an unpowered laser system would produce if the laser was in use.

For rapid analysis of a tissue sample a high frequency of ablation is needed, for example more than 20 Hz (i.e. more than 20 ablations per second, giving more than 20 plumes per second). In some embodiments the frequency of ablation by the laser is at least 40 Hz, such as at least 50 Hz, or at least 100 Hz. In some embodiments the frequency of ablation by the laser is within the range 40-2000 Hz, within the range 40-1500 Hz, within the range 40-500 Hz, within the range 40-200 Hz, within the range 40-150 Hz, or within the range 75-150 Hz. An ablation frequency of more than 40 Hz allows imaging of typical tissue samples to be achieved in a reasonable time. The frequency with which laser pulses can be directed at a spot on the sample (assuming full ablation of the material at that spot) and still be individually resolved determines how quickly the pixels of the image can be obtained. Accordingly, if the duration of laser pulse required to ablate the material at a point means that only less than 5 pulses can be directed at a sample per second, the time taken to study a 1 mmxl mm area with ablation at a spot size of 1 μm would be over two days. With a rate of 40 Hz, this would be around 6-7 hours, with further reductions in the analysis time for further increases in the frequency of pulses. At these frequencies the instrumentation must be able to analyze the ablated material rapidly enough to avoid substantial signal overlap between consecutive ablations, if it is desired to resolve each ablated plume individually. It is preferred that the overlap between signals originating from consecutive plumes is <10% in intensity, more preferably <5%, and ideally <2%. The time required for analysis of a plume will depend on the washout time of the ablation chamber (see ablation chamber section below), the transit time of the plume of sample material to and through the ionization system (optimizations of the transport to the ionization system are discussed above), and the time taken to analyze the ionized material. Each laser pulse can be correlated to a pixel on the image of the sample that is subsequently built up, as discussed in more detail below.

Ablation Chamber

An ablation chamber (which may also be referred to herein as a sample chamber) with a short washout time (e.g. 100 ms or less) is advantageous for use with the apparatus and methods of the invention. A cell with a long washout time will either limit the speed at which an image can be generated or will lead to overlap between signals originating from consecutive sample spots (e.g. Kindness et al. (2003) Clin Chem 49:1916-23, which had signal duration of over 10 seconds). Therefore the washout time of a plume of sample material from the laser ablation cell is a key limiting factor for achieving high resolution without increasing total scan time. Ablation chambers with washout times of <100 ms are known in the art. For example, Gurevich & Hergenroder (2007) J Anal. At. Spectrom., 22:1043-1050 discloses an ablation chamber with a washout time below 100 ms. An ablation chamber was disclosed in reference Wang et al. (2013) Anal. Chem. 85:10107-16 (see also reference WO 2014/146724) which has a washout time of 30 ms or less, thereby permitting a high ablation frequency (e.g. above 20 Hz) and thus rapid analysis. Another such ablation chamber is disclosed in reference WO 2014/127034. The ablation chamber in this document comprises a sample capture cell configured to be arranged operably proximate to the target (the sample capture cell described here is an example of a transfer conduit inlet modification which can be combined with the taper and flow sacrificing modifications of the transfer conduit as described above), the sample capture cell including: a capture cavity having an opening formed in a surface of the capture cell, wherein the capture cavity is configured to receive, through the opening, target material ejected or generated from the laser ablation site and a guide wall exposed within the capture cavity and configured to direct a flow of the carrier gas (also referred to herein as the capture gas) within the capture cavity from an inlet to an outlet such that at least a portion of the target material received within the capture cavity is transferrable into the outlet as a sample. The volume of the capture cavity in the ablation chamber of reference WO 2014/127034 is less than 1 cm3 and can be below 0.005 cm3. Sometimes the ablation chamber has a washout time of 25 ms or less, such as 20 ms or 10 ms or less. A sample cone inlet of the transfer conduit, for example an asymmetric sample cone, can also assist in reducing the washout time of the ablation chamber, and is an alternative to the capture cell discussed here.

An existing LA-ICP-MS system, including a laser ablation chamber, is shown in FIG. 4. The ablation chamber may include a movable sample stage for positioning a sample. A gas source may provide a capture gas that flows through the ablation chamber and carries ablation plumes into an injector tube (also referred to herein as an injector or transfer conduit) that leads to an ICP torch. The injector tube may have flexible tubing between the ablation chamber and the ICP torch, or may be rigid and/or straight. In certain aspects, the injector may be orthogonal to the sample and in-line with the gas flow shown in FIG. 2 or FIG. 3. The LA-ICP-MS system may include one or more additional gas sources for supplying a transfer gas and/or an inner and outer gas (also referred to as auxiliary and plasma gas). In certain aspects, the injector tube may receive a makeup gas downstream of the laser ablation plume introduction to the injector tube. One or more gas flows may include hydrogen. For example, a gas flow may comprise a water or alcohol vapor as described further herein. Alternatively or in addition, a gas flow may be from a pre-mixed compressed gas source that include hydrogen (such as a hydrogen gas, ammonia or methane) as described further herein.

In certain aspects, a laser ablation chamber may comprise a capture gas (that enters the chamber and carries an ablation plume into an injector tube) and optionally further may include a transfer gas (i.e., that enters the injector upstream of the ablation plume). The injector may further include a make-up gas (i.e., that supplements gas in the injector downstream of where the ablation plume enters the injector). The ICP torch may include an inner gas (i.e., an auxiliary gas, which flows to an inner tube of the ICP torch) and an outer gas (i.e., a plasma gas that flows into an outer tube of the ICP torch). Additional gas flows may be present. In certain aspects, hydrogen (e.g., a hydrogen gas or water vapor) may be introduced into one or more of the above gas flows, as described further herein.

Ionization System

Sample material can be ionized by a variety of techniques, such as in a plasma. The use of an ICP is suited for IMS and IMC analyses. ICP is a plasma source in which the energy is supplied by electric currents produced by electromagnetic induction. Typically the plasma source is based on Argon gas. For example, the ionization system may comprise an ICP torch. IMC using ICP in the ionization system is reported on in, for example, Giesen et al. (2014) Nature Methods. 11:417-422 and Wang et al. (2013) Anal. Chem. 85:10107-16.

The ionization system thus receives sample material from the laser sampling system and converts it into elemental ions for detection by the mass spectrometer. If the sample material is not atomized (e.g. the plume of sample material is still in the form of molecules, or even an aerosol of particulate material) then the ionization system acts to break down the material into elemental ions as part of the ionization process.

Mass Spectrometer

As noted above, the third component of the apparatus is a mass spectrometer. Mass analyzers for use in the invention may be selected based on the needs of the operator or specific application. Exemplary types of mass analyzers include quadrupole, time of flight (TOF), magnetic sector, high resolution, single or multicollector based mass spectrometers.

The time taken to analyze the ionized material will depend on the type of mass analyzer/mass spectrometer which is used for detection of ions. For example, instruments which use Faraday cups may be too slow for analyzing rapid signals, but not all analyses will require the rapid analysis of signals, and so the skilled person will be able to select the mass spectrometer or mass analyzer appropriately. Overall, the desired analysis speed (and thus the frequency with which ablation plumes can be interrogated) and degree of multiplexing (number of atoms to be monitored simultaneously/quasi-simultaneously) will dictate the type(s) of mass analyzer which should be used (or, conversely, the choice of mass analyzer will determine the speed and multiplexing which can be achieved).

Typically, time of flight mass spectrometers are used for the recording of fast transient events with the transit durations that are expected from a fast laser ablation setup.

TOF detectors can quasi-simultaneously register multiple masses in a single sample. Whereas TOF mass analyzers are normally unpopular for atomic analysis because of the compromises required to deal with the effects of space charge in the TOF accelerator and flight tube, the effectiveness of the technique can be improved by using it only to detect a subset of ranges. For example, in mass cytometry and imaging mass cytometry, a range may be chosen only such that ions from the labelling atoms used to mark target molecules in a biological samples are detected and so other atoms (e.g. those having an atomic mass below 80) can be removed. This results in a less dense ion beam, enriched in the masses in (for example) the 80-210 dalton region, which can be manipulated and focused more efficiently, thereby facilitating TOF detection and taking advantage of the high spectral scan rate of TOF. Thus, rapid analyses can be achieved by combining TOF detection with choosing labelling atoms that are uncommon in the sample and ideally having masses above the masses seen in an unlabeled sample e.g. by using the higher mass transition elements. Further details on mass cytometry can be found in Tanner et al. Cancer Immunol Immunother (2013) 62:955-965 and U.S. Pat. No. 7,479,630, and on imaging mass cytometry in Giesen et al. (2014) Nature Methods. 11:417-422.

Apparatus in use and additional variants of the invention to which the transfer conduit modifications described above can be applied

The apparatus of the invention may be used for analysis or imaging of a biological sample, which may be on transparent substrate. In imaging embodiments, generally the laser may be operated with continuous train of pulses or in bursts of pulses directed to different positions of the sample, referred to as “spots of interest,” or “locations or zones of ablation.” The pulses may be directed to spots in a set pattern, such as a raster for two-dimensional imaging. Alternatively, a plurality of individual spots at different locations (for example, corresponding to individual cells) may be ablated. In some embodiments, the laser emits a burst of pulses producing a plume coming from the same pixel (i.e. the same location on the target). Ablation plumes produced by individual pulses within the burst are expected to fuse into one plume and travel within the instrument in such a way that they will be distinct from the plume produced from another pixel. To distinguish individual pixels, the time duration between bursts (pixel interrogation that can be just one pulse or 100 pulses) is maintained above a certain limit determined by the time spreading of the ion signal (at the detector) from an individual pixel.

In accordance with the present teachings, each separate sample plume can be distinctly analyzed by the mass analyzer. In one aspect, the device is configured so that spreading of the plume in ablation cell (ablation system) and transfer conduit is smaller than the spreading that occurs in the ionization system and the mass analyzer. In one aspect, plumes may be distinctly analyzed by transferring each ablated plume to the ionization system in a time period that is within the cumulative transit time of the plume to the ionization system and ion detection by the mass analyzer. This can be accomplished by capturing each sample plume through a gas flow and under a transfer configuration such that the ratio between the plume broadening during transfer time period (i.e., transfer of the ablation plume from the site of ablation to the plasma) and the broadening during ion transit time period (i.e., transfer of ions from the plasma to the mass analyzer) is equal to or less than one.

Generally, the sample particle size limit for which an ionization system (e.g. an ICP) can effectively vaporize and ionize for the purpose of analytical detection is in the order of about 10 μm or less. Particles produced by the laser ablation at 1 micrometer scale are below 1 micrometer and are well suited for an ICP ion source. For discrete particles analysis (such as may be carried out using CyTOF® instrumentation, Fluidigm Canada Inc.), the typical rate at which these particles can be ionized and analytically detected can be a function of the cumulative broadening or spread of transit time of the sample in the plasma while the particles are being evaporated and ionized and of the ions' transit time broadening or spread between the ICP and its detection by the mass analyzer. Generally the cumulative time broadening or spread can be of the order of about 200 μs duration. Consequently, for particles of 10 μm or less that are spatially separated, analyzing each distinct particle can be achieved by transferring each particle to the ionization system (e.g. ICP) in a time period of the order of 200 μs. In some embodiments the particles are transferred to the ionization system (e.g. ICP) in less than 200 μs, or less than 150 μs. Accordingly, in a sample introduction system where imaging of biological samples can be performed by laser ablation, a laser system can be configured to operate with sufficiently focused laser pulses to ablate a sample area in the order of about 1 μm, such as the application of a femtosecond pulsed laser for example. With this configuration, the ablated plumes formed by each laser pulse can include sample particulates with dimensions typically about 1 μm or less. Under certain conditions as described herein, these particulates can be captured and transferred to meet the transfer time period as required and, subsequently, each distinct plume can be effectively vaporized and ionized by the ionization system.

Additionally, while operating the laser with continuous series of pulses such as in the case of rasterizing across a sample surface for two dimensional imaging, the distinctiveness of each plume and the spatial separation between each subsequent plume can be maintained between the plume's zone of formation and the point of vaporization and ionization in the ionization system ion source. For example, as a plume is carried through a conduit the particles in the plume can spread and expand outwardly in a radial direction before it enters ionization system (e.g. the plasma of the ICP). Spreading of the particles produced in the plume can depend on its diffusion coefficient, the velocity profile of carrier flow and the distribution of particle density as it is formed and as it evolves during transit to the ionization system. For example, the femtosecond laser ablation spot size of 1 μm can produce a plume with an initial cross section diameter of about 100 μm or less before further spreading during its transit. The extent of spreading of the plume can also be a function of the dimension of the ablated particle; larger particles tend to have lower diffusion spreading but with higher momentum resulting in potential losses due to contacting the inner walls of the transfer conduit/injector tube. It is thus desirous to minimize the plume spreading and/or to transfer the plume to the ionization system within sufficient time to vaporize and ionize before the extent of spreading presents any challenging effects.

Accordingly, in various embodiments, the use of a laser for ablating 1 μm sample spots and efficiently transporting the plume so that the spreading is maintained within the internal diameter of the transfer conduit/injector tube can be achieved by the exemplary arrangements described herein and in the accompanying drawings.

For a given laser ablation system and given sample, ablated plumes expand after the laser ablation until they reach a characteristic volume, referred to as the “sampling volume.” It is desirable to configure the system to minimize the sampling volume, and to increase the velocity with which the gas flow carries the plume away from the sampling volume. The combination of a small sampling volume and fast gas flow reduces the time spreading of the plume transfer into the transfer conduit/injector. The sampling volume can be described by the envelope of the plume at the moment when the velocity of plume expansion in any of the dimensions falls substantially (^{˜}10 times) below the sonic velocity of the surrounding gas media. Without limitation, exemplary sampling volumes may be in the range 10-6 mm3-10 mm3. Often the sampling volume is in the range 0.001 mm3-1 mm3. The capture flow, where present, flows into at least part of the sampling volume and carries at least a portion of the plume into the transfer conduit/injector whereupon it may be transported by the transfer flow to the ionization system (e.g. ICP). It is desirable that the velocity of capture flow when it enters the sampling volume be substantial (e.g., >1 m/s, >10 m/s, >100 m/s, or >500 m/s). In some embodiments the velocity of capture flow when it enters the sampling volume can be estimated by measuring the velocity of the capture flow into the transfer conduit/injector (e.g., though the transfer conduit/injector aperture). In some embodiments this measured velocity is >1 m/s, >10 m/s, >100 m/s, or >500 m/s. In contrast to the present invention, if the plume is not swept away rapidly, it will continue to expand and diffuse, undesirably filling the entire ablation cell.

In one aspect, the invention provides a laser ablation configuration in which the laser beam is directed to a target. In one embodiment, the target comprises a substrate and a sample disposed on the substrate. In one embodiment the substrate is transparent and the target is a transparent target.

In one aspect, the invention provides a laser ablation configuration, for “through-target” ablation. In this configuration, the pulse of a laser beam is directed through the transparent target and a sample plume (the “ablated plume” or the “plume”) is formed downstream of the beam into a transfer conduit/injector. Through-target illumination is advantageous for optimizing transit time broadening due to the removal of optical elements (windows, objective lenses, etc.) from the straight path of the plume. In one aspect, the invention provides a laser ablation system comprising (a) a laser capable of producing laser illumination; (b) a laser ablation cell (or laser ablation system) into which a transparent target may be introduced and an transfer conduit/injector with an opening through which an ablated plume may enter, where the laser illumination originates from a surface on one side of the transparent target and the transfer conduit/injector opening is on the other side. Other features that may be included in the system are described throughout this disclosure including the examples.

In certain aspects, a smaller ablation spot size (higher resolution) may be achieved with a high numerical aperture lens, such as an immersion lens. Such an immersion lens may be configured for through-target ablation (e.g., of a thin sample, such as a tissue section of less than 500 nm in diameter).

Thus, in operation of one apparatus according to the invention, the sample is taken into the apparatus, is sampled to generate ionised material using a laser system comprising optics in which laser radiation is directed onto the sample though an immersion lens (sampling may generate vaporous/particular material, which is subsequently ionised by the ionisation system), and the ions of the sample material are passed into the detector system.

The present invention overcomes the limitations of traditional IMC and IMS by utilising an immersion medium. The immersion medium has a refractive index which is greater than 1.0 and is placed between the objective lens and the sample stage. In this way, the apparatus of the present invention achieves numerical apertures of greater than 1.0 and so the spot size of the laser is less than 200 nm, less than 150 nm, or less than 100 nm. Thus, the present invention provides an apparatus for imaging mass cytometry with spatial resolution of 200 nm or better, 150 nm or better, or 100 nm or better.

Accordingly in operation, the sample stage holds the sample, typically wherein the sample is on a sample carrier and the same stage holds the sample carrier. Laser radiation is then directed through the optics of the apparatus, through the objective lens and immersion medium to the sample, where the radiation ablates material from the sample.

In order to achieve the optimal focusing conditions for the laser, the immersion medium of the present invention has a refractive index of greater than 1.00, such as 1.33 or greater, 1.50 or greater, 2.00 or greater, or 2.50 or greater.

Furthermore, in order to reconstruct the image of a single layer of the thickness (or less than the thickness) of a biological cell or to read a thicker specimen layer by layer and generate a 3D image, as discussed further herein, the sample preferably has a thickness of 100 micrometers or below, such as 10 micrometers or below, 5 micrometers or below, 2 micrometers or below, or 100 nm or below, or 50 nm or below, or 30 nm or below. In some embodiments described in more detail herein, the combination of the objective lens and the immersion medium is referred to as an immersion lens.

When a liquid immersion medium is used, the sample needs to be positioned on the opposite side of the sample carrier to the liquid medium (as illustrated in FIG. 3) so that a carrier gas can collect the ablated material. Accordingly, through-sample carrier ablation techniques must be applied here. This has the additional benefit of a smaller achievable working distance for the ablation material collection hardware, and no need to bend the transport conduit between the sample chamber and the detector. This also leads to reductions in the transient time, thus increasing the achievable ablation rate in spots per second.

Accordingly, the present invention provides an apparatus wherein the solid immersion medium is a hemispherical solid immersion lens or a Weierstrass solid immersion lens. The biological sample can be mounted on the opposite side of the sample stage to the solid immersion material. The stage on which the sample is mounted can be made of material of the same refractive index as the solid immersion lens and the solid immersion lens can be made thinner by an amount equal to the thickness of the substrate to maintain the focal spot location.

In various embodiments, the sample of interest can be configured for laser ablation by using a sample formatted to be compatible with a transparent target. A sample can be placed onto a transparent substrate, incorporated into a transparent substrate or can be formed as the transparent target. Suitable laser-transparent substrates may comprise glass, plastic, quartz and other materials. Generally the substrate is substantially planar or flat. In some embodiments the substrate is curved. Substrates are from 0.1 mm up to 3 mm thick, in certain embodiments. In some embodiments, the substrate is encoded (see, e.g., Antonov, A. and Bandura, D., 2012, U.S. Pat. Pub. 2012/0061561, incorporated by reference herein). In this configuration, the pulse of a laser beam is directed through the transparent target and a sample plume (the “ablated plume” or the “plume”) is formed downstream of the beam into a transfer conduit/injector.

The transfer conduit (i.e., injector tube) can have an inlet configured to capture the ablated plume; such as the inlet formed as a sample cone having a small opening or aperture. In this configuration, the sample cone can be positioned near the area, or zone, where the plume is formed. For example, the opening of the sample cone may be positioned from 10 μm to 1000 μm from the transparent target, such as about 100 μm away from the transparent target. Consequently, the ablated plume can be generated and formed at least partially within the expanding region of the cone. In some embodiments, the diameter of the aperture and/or dimensions of the spacing (including angles) are adjustable to permit optimization under various conditions. For example, with a plume having a cross sectional diameter in the scale of 100 the diameter of the aperture can be sized in the order of 100 μm with sufficient clearance to prevent perturbation to the plume as it passes.

The transfer conduit can continue downstream of the sampling cone for receiving the ablated plume in such a configuration as to encourage the movement of the plume and preserve the spatial distinctiveness of each subsequent plume as a function of the laser pulses. Accordingly, a flow of gas can be introduced to aid in directing the plume through the aperture of the sampling cone in order to capture (capture flow) each plume distinctively while an additional flow of gas can be introduced to the transfer conduit/injector for transferring (transfer flow or sheath flow) each distinctly captured plume towards the ionization system. Another function of the transfer or sheath flow is to prevent the particles produced in the plume from contacting the walls of the transfer conduit/injector. The gas(es) may be, for example, and without limitation, argon, xenon, helium, nitrogen, or mixtures of these. In some embodiments the gas is argon. The capture flow gas and the transfer flow gas may be the same or different.

It is within the ability of one of ordinary skill in this field guided by this disclosure to select or determine gas flow rates suitable for the present invention. The total flow through the transfer conduit is typically dictated by the requirements of the ionization source (e.g. an ICP ionization source). The laser ablation setup needs to provide the flow that would match these requirements. For example, the transfer conduit may have an inner diameter of 1 mm or less, optionally in conjunction with the cumulative gas flow rate of about 1 liter per minute (0.1 liter per minute capture flow plus 0.9 liter per minute transfer flow). It would be expected that smaller or larger diameter transfer conduits, along with the correspondingly selected gas flow rates, can be applied to the various geometries presented with similar expected results. Conditions for maintaining non-turbulent gas dynamic within the transfer conduit in order for preserving the distinctiveness of each separate ablated plume are desirable.

As described herein, given a particular configuration of elements (e.g., a particular configuration of gas inlet positions, apertures, transfer conduit properties, and other elements), the capture and transfer flow rates are selected to result in transfer of each ablated plume to the ionization system (e.g. ICP) in a time period that is within the cumulative transit time of the plume between the ionization system and its detection by the mass analyzer. This can be accomplished by capturing each sample plume through a gas flow and under a transfer configuration such that the ratio between the plume broadening during transfer time period and the broadening during ion transit time period is equal to or less than one. That is, the time broadening (or time spreading) of the transit signal that is important. ICP-MS devices (such as the CyTOF® ICP-TOF instrument, Fluidigm Canada Inc.) are characterized by an inherent broadening of the signal. In the case of laser ablation, the act of injecting a single plume may or may not be fast in comparison to the time spreading on the ICP-MS itself. The spreading of the plume before ionization depends on the design of the laser ablation system, and in particular the ablation chamber and the transfer conduit. It is desirable that the laser ablation system and the transfer conduit do not spread the original ablation plume more than the inherent broadening of the remaining instrument. This condition ensures that the spike in detection signal produced by ablation plume is as sharp (in time) as it could be for the chosen instrument. If the spreading of the plume is much longer then the spreading in an, for example, ICP-MS system, an event of laser ablation from a single pulse will come out much broader at the detector. But, if the spreading in the laser ablation section is smaller than the instrument spreading the total spreading will be dominated by the instrument spreading. Thus, one can measure the instrument spreading using calibration beads and then measure the total spreading from a single laser pulse and compare these two numbers. If the spreading from the laser ablation is smaller than the spreading from the instrument, the total spreading will be less than 2-times of the instrument spreading.

The characteristic instrument time broadening can be measured experimentally, for example using labeled cells or calibration beads. Any time a single bead enters a mass cytometer (e.g., CyTOF® ICP-TOF instrument) the bead goes through evaporation and ionization in plasma and then goes through the mass analyzer until its signal reaches detector. The transient event is detected and used to record information about the particular bead, such as the width of the transient signal (which represents the time spread from a single event) and the value of spreading that occurs starting from the ICP source and ending at the detector.

In some embodiments, the device is configured to allow time spreading of between 10 and 1000 microseconds for the path defined between the sample and the ion detector of the mass analyzer.

Typical capture flow rates are in the range of 0.1 to 1 Lpm. An optimal capture flow rate can be determined experimentally, but is usually at the lower end of the range (e.g., about 0.1 Lpm). Typical transfer flow rates are in the range of 0.1 to 1 Lpm. An optimal transfer flow rate can be determined experimentally, but is usually at the higher end of the range (e.g., about 0.9 Lpm). In some embodiments, the capture flow rate is lower than the transfer flow rate. The transfer flow rate can be 0 in some cases, for example if the capture flow rate is approximately 1 Lpm. Often the transfer flow rate is in the range of 0.4-1 Lpm (e.g., 0.4, 0.6, 0.8 or 1 Lpm).

While the present teachings are described in conjunction with various embodiments, it is not intended that the present teachings be limited to such embodiments. On the contrary, the present teachings encompass various alternatives, modifications, and equivalents, as will be appreciated by those of skill in the art. For example, in the various examples illustrated in the figures, the transfer conduit/injector tube has been generally described with a 1 mm inner diameter in conjunction with the cumulative gas flow rate of about 1 liter per minute (0.1 plus 0.9 liter per minute). It would be expected that smaller or larger diameter transfer conduit/injectors, along with the correspondingly selected gas flow rates, can be applied to the various geometries presented with similar expected results. However, conditions for maintaining non-turbulent or nearly non-turbulent gas dynamic within the injector tube in order for preserving the distinctiveness of each separate ablated plume may be desirable.

Furthermore, in some instances of elevated laser pulse rates, more than one ablated plume can be distinctly captured and transferred to the ionization system (e.g. ICP) within the cumulative transit time spread as discussed above. For example, at a repetition rate of 10 kHz a pulsed laser can generate two ablated plumes in 200 μs that can be subsequently transferred to the ICP for ionization. The ions generated from the two discrete plumes can be analyzed as a single discrete packet of ions by the mass analyzer. Consequently, while the laser remains at the same ablation spot or while the laser's rate of movement over a trace of continuous spots is less than the repetition rate, the ablated plumes, and the subsequent ions, can provide an accumulative mass analysis at the same ablation spot or provide an average mass distribution along the trace respectively. It should be noted that laser repetition rate as high as several MHz can be employed resulting in a signal that represents averaging of many laser pulses. The laser can also be fired in bursts to provide a gap in the data flow between individual sampling locations (or pixels).

It will be understood that the methods and devices of the invention may be used with any of a variety of types of samples, e.g., biological samples. In one approach the sample is cellular material, such as a tissue section, cell monolayer, cell preparation, or the like. A sample may be a thinly sectioned biological tissue up to 100 micrometers thickness, a tissue sample in the order of millimeters thickness, or an un-sectioned tissue sample. In one example, thin tissue sections (such as paraffin embedded sections) may be used. For illustration, some tissue sections have a thickness of 10 nanometers to −10 micrometers. In some cases, the sample is a group of cells, or one or more selected cells from a group of cells. See, e.g., Antonov, A. and Bandura, D., 2012, U.S. Pat. Pub. 2012/0061561, incorporated by reference herein.

Constructing an image IMS and IMC can provide signals for multiple labelling atoms/elemental tags in plumes. Detection of a label in a plume reveals the presence of its cognate target at the position of ablation (or, correspondingly, the position of desorption of the slug of material). By generating a series of plumes at known spatial locations on the sample's surface the MS signals reveal the location of the labels on the sample, and so the signals can be used to construct an image of the sample. By labelling multiple targets with distinguishable labels it is possible to associate the location of labelling atoms with the location of cognate targets, so the invention can build complex images, reaching levels of multiplexing which far exceed those achievable using existing techniques. For instance, the GRAPHIS package from Kylebank Software may be used, but other packages such as TERAPLOT, ImageJ and CellProfiler can also be used. Imaging using MS data from techniques such as MALDI-MSI is known in the art e.g. Robichaud et al. (2013) J Am Soc Mass Spectrom 24(5):718-21 discloses the ‘MSiReader’ interface to view and analyze MS imaging files on a Matlab platform, and there are also instruments for rapid data exploration and visualization of both 2D and 3D MSI data sets in full spatial and spectral resolution e.g. the ‘Datacube Explorer’ program.

Samples

The invention provides a method of imaging a sample. All kinds of samples can be analysed by the methods, including alloys, geological samples and archaeological samples. Biological samples can also be analyzed. Such samples comprise a plurality of cells, a plurality of these cells can be subjected to IMS and/or IMC in order to provide an image of these cells in the sample. In general, the invention can be used to analyze tissue samples which are now studied by IHC techniques, but with the use of labels which are suitable for detection by IMC.

Any suitable tissue sample can be analyzed. For example, the tissue can be epithelium tissue, muscle tissue, nerve tissue, etc., and combinations thereof. For diagnostic or prognostic purposes the tissue can be from a tumor. In some embodiments a sample may be from a known tissue, but it might be unknown whether the sample contains tumor cells. Imaging can reveal the presence of targets which indicate the presence of a tumor, thus facilitating diagnosis. The tissue sample may comprise breast cancer tissue, for example human breast cancer tissue or human mammary epithelial cells (HMLE). The tissue sample may comprise formalin-fixed, paraffin-embedded (FFPE) tissue, may be a frozen tissue, or may be a tissue embedded in a suitable resin. The tissues can be obtained from any living multicellular organism, but will usually be human.

The tissue sample will usually be a section e.g. having a thickness within the range of 2-10 such as between 4-6 Thinner tissue sections of less than 2 μm thickness can also be analyzed, such as less than 1 less than 500 nm, less than 250 nm or even 100 nm or less. A thinner tissue sample would produce lower signal due to the reduction of the volume of sample ablated by a later pulse, but the thinner the section, the more sections can be generated from a tissue sample, which provides benefits in terms of 3-D imaging by imaging multiple sections. However, a thinner section (e.g., that is at or less than the resolution of laser ablation) may allow easier ablation through the slide (e.g., the entire depth of the tissue section at a laser ablation spot may be ablated). Techniques for preparing such sections are well known from the field of IHC e.g. using microtomes, including dehydration steps, including embedding, etc. Thus a tissue may be chemically fixed and then sections can be prepared in the desired plane. Cryosectioning or laser capture microdissection can also be used for preparing tissue samples. Samples may be permeabilized e.g. to permit of reagents for labelling of intracellular targets (see above).

The size of a tissue sample to be analyzed will be similar to current IHC methods, although the maximum size will be dictated by the laser ablation apparatus, and in particular by the size of sample which can fit into its ablation chamber. A size of up to 5 mm×5 mm is typical, but smaller samples (e.g. 1 mm×1 mm) are also useful (these dimensions refer to the size of the section, not its thickness).

Labelling of the Tissue Sample

In some embodiments, as described above, the apparatus and methods of the invention detect atoms that have been added to a sample (i.e. which are not normally present). Such atoms are called labelling atoms (the labelling atoms therefore represent an elemental tag). The sample is typically a biological sample comprising cells, and the labelling atoms are used to label target molecules in the cells/on the cell surface. In some embodiments, simultaneous detection of many more than one labelling atom, permitting multiplex label detection e.g. at least 3, 4, 5, 10, 20, 30, 32, 40, 50 or even 100 different labelling atoms is enabled. By labelling different targets with different labelling atoms it is possible to determine the presence of multiple targets on a single cell.

Labelling atoms that can be used with the invention include any species that are detectable by MS and that are substantially absent from the unlabelled sample. Thus, for instance, 12C atoms would be unsuitable as labelling atoms because they are naturally abundant, whereas 11C could in theory be used because it is an artificial isotope which does not occur naturally. In preferred embodiments, however, the labelling atoms are transition metals, such as the rare earth metals (the 15 lanthanides, plus scandium and yttrium). These 17 elements provide many different isotopes which can be easily distinguished by MS. A wide variety of these elements are available in the form of enriched isotopes e.g. samarium has 6 stable isotopes, and neodymium has 7 stable isotopes, all of which are available in enriched form. The 15 lanthanide elements provide at least 37 isotopes that have non-redundantly unique masses. Examples of elements that are suitable for use as labelling atoms include Lanthanum (La), Cerium (Ce), Praseodymium (Pr), Neodymium (Nd), Promethium (Pm), Samarium (Sm), Europium (Eu), Gadolinium, (Gd), Terbium (Tb), Dysprosium (Dy), Holmium (Ho), Erbium (Er), Thulium (Tm), Ytterbium (Yb), Lutetium (Lu), Scandium (Sc), and Yttrium (Y). In addition to rare earth metals, other metal atoms are suitable for detection by MS e.g. gold (Au), platinum (Pt), iridium (Ir), rhodium (Rh), bismuth (Bi), etc. The use of radioactive isotopes is not preferred as they are less convenient to handle and are unstable e.g. Pm is not a preferred labelling atom among the lanthanides.

In order to facilitate TOF analysis (see above) it is helpful to use labelling atoms with an atomic mass within the range 80-250 e.g. within the range 80-210, or within the range 100-200. This range includes all of the lanthanides, but excludes Sc and Y. The range of 100-200 permits a theoretical 101-plex analysis by using different labelling atoms, while permitting the invention to take advantage of the high spectral scan rate of TOF MS. As mentioned above, by choosing labelling atoms whose masses lie in a window above those seen in an unlabelled sample (e.g. within the range of 100-200), TOF detection can be used to provide rapid analyses at biologically significant levels.

Labelling the sample generally requires that the labelling atoms are attached to one member of a specific binding pair (sbp). This labelled sbp is contacted with a sample such that it can interact with the other member of the sbp (the target sbp member) if it is present, thereby localizing the labelling atom to a target molecule in the sample. The method of the invention then detects the presence of the labelling atom on a particle as it is analyzed by the mass cytometer. Rare earth metals and other labelling atoms can be conjugated to sbp members by known techniques e.g. Bruckner et al. (2013) Anal. Chem. 86:585-91 describes the attachment of lanthanide atoms to oligonucleotide probes for MS detection, Gao & Yu (2007) Biosensor Bioelectronics 22:933-40 describes the use of ruthenium to label oligonucleotides, and Fluidigm Canada sells the MaxPar™ metal labelling kits which can be used to conjugate over 30 different labelling atoms to proteins (including antibodies).

Various numbers of labelling atoms can be attached to a single sbp member, and greater sensitivity can be achieved when more labelling atoms are attached to any sbp member. For example greater than 10, 20, 30, 40, 50, 60, 70, 80, 90 or 100 labelling atoms can be attached to a sbp member. For example, monodisperse polymers containing multiple monomer units may be used to form an elemental tag, each containing a chelator such as DTPA. DTPA, for example, binds 3+ lanthanide ions with a dissociation constant of about 10-6M [Tanner et al. Cancer Immunol Immunother (2013) 62:955-965]. These polymers can terminate in a thiol-reactive group (e.g. maleimide) which can be used for attaching to a sbp member. For example, the thiol-reactive group may bind to the Fc region of an antibody. Other functional groups can also be used for conjugation of these polymers e.g. amine-reactive groups such as N-hydroxy succinimide esters, or groups reactive against carboxyls or against an antibody's glycosylation. Any number of polymers may bind to each sbp member. Specific examples of polymers that may be used include straight-chain (“X8”) polymers or third-generation dendritic (“DN3”) polymers, both available as MaxPar™ reagents. Use of metal nanoparticles can also be used to increase the number of atoms in a label.

As mentioned above, labelling atoms are attached to a sbp member, and this labelled sbp member is contacted with the sample where it can find the target sbp member (if present), thereby forming a labelled sbp. The labelled sbp member can comprise any chemical structure that is suitable for attaching to a labelling atom and then for detection according to the invention.

In general terms, methods of the invention can be based on any sbp which is already known for use in determining the presence of target molecules in samples (e.g. as used in IHC or fluorescence in situ hybridisation, FISH) or fluorescence-based flow cytometry, but the sbp member which is contacted with the sample will carry a labelling atom which is detectable by MS. Thus, the invention can readily be implemented by using available flow cytometry reagents, merely by modifying the labels which have previously been used e.g. to modify a FISH probe to carry a label which can be detected by MS.

The sbp may comprise any of the following: a nucleic acid duplex; an antibody/antigen complex; a receptor/ligand pair; or an aptamer/target pair. Thus a labelling atom can be attached to a nucleic acid probe which is then contacted with a sample so that the probe can hybridize to complementary nucleic acid(s) therein e.g. to form a DNA/DNA duplex, a DNA/RNA duplex, or a RNA/RNA duplex. Similarly, a labelling atom can be attached to an antibody which is then contacted with a sample so that it can bind to its antigen. A labelling atom can be attached to a ligand which is then contacted with a sample so that it can bind to its receptor. A labelling atom can be attached to an aptamer ligand which is then contacted with a sample so that it can bind to its target. Thus labelled sbp members can be used to detect a variety of target molecules in a sample, including DNA sequences, RNA sequences, proteins, sugars, lipids, or metabolites.

In a typical embodiment the labelled sbp member is an antibody. Labelling of the antibody can be achieved through conjugation of one or more labelling atom binding molecules to the antibody, for example using the MaxPar™ conjugation kit as described above. The target molecule of an antibody is called its antigen, and may be a protein, carbohydrate, nucleic acid etc. Antibodies which recognize cellular proteins that are useful for mass cytometry are already widely available for IHC usage, and by using labelling atoms instead of current labelling techniques (e.g. fluorescence) these known antibodies can be readily adapted for use in methods of the invention, but with the benefit of increasing multiplexing capability. Antibodies used with the invention can recognize targets on the cell surface or targets within a cell. Antibodies can recognize a variety of targets e.g. they can specifically recognize individual proteins, or can recognize multiple related proteins which share common epitopes, or can recognize specific post-translational modifications on proteins (e.g. to distinguish between tyrosine and phospho-tyrosine on a protein of interest, to distinguish between lysine and acetyl-lysine, to detect ubiquitination, etc.). After binding to its target, labelling atom(s) conjugated to an antibody can be detected to reveal the presence of that target in a sample.

The labelled sbp member will usually interact directly with a target sbp member in the sample. In some embodiments, however, it is possible for the labelled sbp member to interact with a target sbp member indirectly e.g. a primary antibody may bind to the target sbp member, and a labelled secondary antibody can then bind to the primary antibody, in the manner of a sandwich assay. Usually, however, the invention relies on direct interactions, as this can be achieved more easily and permits higher multiplexing. In both cases, however, a sample is contacted with a sbp member which can bind to a target sbp member in the sample, and at a later stage label attached to the target sbp member is detected.

One feature of the invention is its ability to detect multiple (e.g. 10 or more, and even up to 100 or more) different target sbp members in a sample e.g. to detect multiple different proteins and/or multiple different nucleic acid sequences in samples. To permit differential detection of these target sbp members their respective sbp members should carry different labelling atoms such that their signals can be distinguished by MS. For instance, where ten different proteins are being detected, ten different antibodies (each specific for a different target protein) can be used, each of which carries a unique label, such that signals from the different antibodies can be distinguished. In some embodiments, it is desirable to use multiple different antibodies against a single target e.g. which recognize different epitopes on the same protein.

If more than one labelled antibody is used, it is preferable that the antibodies should have similar affinities for their respective antigens, as this helps to ensure that the relationship between the quantity of labelling atoms detected by MS and the abundance of the target antigen will be more consistent across different sbps (particularly at high scanning frequencies).

If a target sbp member is located intracellularly, it will typically be necessary to permeabilize cell membranes before or during contacting of the sample with the labels. For example when the target is a DNA sequence but the labelled sbp member cannot penetrate the membranes of live cells, the cells of the sample can be fixed and permeabilized. The labelled sbp member can then enter the cell and form a sbp with the target sbp member.

Usually, a method of the invention will detect at least one intracellular target and at least one cell surface target. In some embodiments, however, the invention can be used to detect a plurality of cell surface targets while ignoring intracellular targets. Overall, the choice of targets will be determined by the information which is desired from the method.

Labelling of the sample is not wholly reliant on sbp. In some instances classical dyes can be used to highlight desired features on the tissue. In a number of cases the dyes used for microscopy contain elements that are rare in the natural cell state. Thus, in the process of dyeing the tissue it gets enriched with particular elements that are readable by apparatus and methods described herein.

Accordingly, in some embodiments, the methods of analysis described above comprise the step of labelling a sample with at least one labelling atom. This atom can then be detected using the methods described above.

Signal Enhancement

Aspects of the subject application include signal enhancement by addition of hydrogen in LA-ICP-MS as described further herein. The LA-ICP-MS system may have one or more gas flows shown in FIG. 4, such as a capture gas flow, transfer gas flow, inner (auxiliary) gas flow to an inner torch tube, and/or an outer (plasma) gas flow to an outer torch tube. Of note, the gas sources shown in FIG. 4 could be configured differently, such that a pre-mixed or humidified gas is supplied to any one or more of a capture gas flow, transfer gas flow, inner gas flow and/or outer gas flow. In certain aspects, a LA-ICP-MS system may include 3 gas sources, such as a separate gas source for a transfer flow as compared to the inner and outer gas flow. Alternatively or in addition, the laser ablation system may comprise an injector orthogonal to the sample, for example as shown in FIG. 2-3. In certain aspects, only one gas flow (e.g., a capture gas) may flow through the injector. In certain aspects, the injector includes a makeup gas flow downstream of a laser ablation plume.

Aspects of the subject application include apparatus and workflows for imaging mass spectrometry (IMS) that improve speed of sample acquisition, signal sensitivity, and/or signal stability. Imaging mass cytometry (IMC) is the detection of mass tags by imaging mass spectrometry with cellular or subcellular spatial resolution. IMC systems and methods may include any of the aspects described in the subject application. In certain aspects, mass cytometry may comprise a laser ablation (LA) inductively coupled plasma (ICP) mass spectrometry (MS). The use of non-endogenous elements, such as heavy metal mass tags, allows for detection over endogenous elements. Such endogenous elements, such as carbon, oxygen, nitrogen and light metals such as calcium may be depleted by the mass spectrometer, such as by a high pass mass filter (e.g., a RF quadrupole). In certain aspects, argon dimer (a byproduct of argon based ICP) may also be depleted, such as by a high pass mass filter with a cutoff of at least 80 amu.

The heavy metal mass tags may comprise a heavy metal above 80 amu, e.g., as described further herein. In certain aspects, the individual mass tags may comprise multiple labeling atoms of an enriched heavy metal isotope. Such labeling atoms may be on a polymer, such as bound by chelating pendant groups on a polymer, which is in then conjugated to a specific binding partner (SBP) that binds a specific target, such as an antibody that binds a specific protein target. For example, Maxpar tags provided by Fluidigm each comprise a polymer loaded with multiple labeling atoms of a single isotope, such as a lanthanide isotope, and may be conjugated to an antibody that binds a specific protein expressed by a cell. The detection of the isotope by ICP-MS indicates that the corresponding target (e.g., protein) was present.

The use of enriched isotopes as labeling atoms increases the number of different targets that can be detected over what could be detected with element mass tags that comprise a natural mixture of isotopes. However, the use of more than 20, more than 30, or more than 40 isotope mass tags often includes isotopes that are 16 amu from one another, such that oxides of one mass tag may interfere with the detection of another mass tag comprising an isotope with 16 amu greater mass. Oxides, such as of lanthanides used as mass tags, are a byproduct of ICP-based atomization and ionization. In certain aspect, a method or system for increased sensitivity or signal stability may be implemented in a way that avoids excess oxide formation.

As such, oxidation may be uniquely problematic for atomic IMC, as opposed to other forms of IMS such as MALDI, as atomic mass detection of metal isotopes that are 16 amu from other mass tags is susceptible to oxide spillover. This consideration is further complicated by a desire for sensitive and stable detection in each laser ablated spot (pixel). Each ablation produces a small (e.g., micron or sub-micron sized) ablation crater in which a small number of a given mass tag may be present. Further, IMC relies on an ability to accurately compare the expression of different targets (e.g., each measured as a signal in a different mass channel corresponding to the different masses of isotope mass tags) across a sample such as a tissue section.

In certain aspects, an IMC system may be used for suspension mass cytometry, such as when an ICP torch of the system can be coupled to a spray chamber for introducing whole cells instead of the laser ablation source. As such, the ICP torch may be capable of atomization and ionization of whole cells (e.g., cells up to at least 15 microns, or up to at least 20 microns in diameter). As such, the plasma produced by the ICP torch may not be designed specifically for efficient ionization and/or atomization of laser ablation plumes (e.g., may have a longer path length than would be needed for laser ablation plumes). Alternatively, designing an LA-ICP-MS system to have a short transient may include reducing a path length of a plasma, and may result in inefficient ionization and/or atomization (e.g., unless modified by introducing hydrogen as described herein). Inventors have found that humidity levels impact sensitivity of an IMC system, and may lead to signal drift such as when humidity in the system tends to decrease over a sample run (e.g., when there is some initial level of humidity due to air in the ablation chamber prior to operation). Indeed, as discussed further herein, water vapor or hydrogen gas have both been found to increase signal sensitivity and may further improve signal stability. As such, the efficiency of ionization and/or atomization (e.g., measured by an increased sensitivity in one or more mass channels, such as for one or more labeling atoms) may be improved by addition of one or more hydrogen containing molecules to gas flow as described further herein. For example, a suitable hydrogen-containing molecule may be water or an alcohol (such as ethanol) as a vapor. Alternatively or in addition, a suitable hydrogen containing molecule may be hydrogen gas, methane, or ammonium, e.g., provided in premixture with helium or argon.

In certain aspects, portions of the LA-ICP-MS system may be open to the atmosphere, such that air may be present in the laser ablation chamber, fluidics, and/or ICP torch. Such air may eventually be purged or consumed by the operation of the ICP-MS system. However, changing levels of humidity and/or oxygen due to such air may affect the efficiency of ICP plasma, such as the ionization efficiency and/or oxide formation. In certain aspects, humidity may be controlled throughout a sample run as described herein (e.g., such that mass signal is increased and/or stabilized but oxidation is minimized). Alternatively or in addition, hydrogen may be pre-mixed with a gas (such as helium or argon) to increase sensitivity and/or signal stability.

The inventors have found that the addition of water or hydrogen during LA-ICP-MS analysis of heavy metal mass tags can improve sensitivity and control signal stability. In certain aspects, one or more hydrogen-containing gases such as hydrogen gas, water vapor, methane and/or ammonia may be introduced during LA-ICP-MS. In certain aspects, the gas (such as hydrogen gas, methane or ammonia) may be provided pre-mixed with an ICP gas such as helium or argon in a pressurized gas source. In certain aspects, water vapor may be mixed with a gas, such as argon gas.

In general, hydrogen gas may be provided to the ICP source at a flow rate sufficient to provide signal enhancement and/or stability.

The signal enhancement may be for one or more mass channels, such as for metal isotope channels of mass tags used to label a biological sample analyzed by the apparatus. In certain aspects the metal isotopes include lanthanide isotopes. The signal enhancement may be at least 20% at least 30%, at least 50%, at least 80% or at least 100% compared to a signal in the absence of hydrogen gas. In certain aspects, the signal enhancement is the mean signal enhancement across the range of mass channels in which signal (e.g., from metal isotope mass tags) is detected. In certain aspects, the mean signal enhancement for lanthanide isotopes measured by at least 10 counts is at least 20% at least 30%, or at least 50%. Signal enhancement, also referred to sensitivity improvement, may be measure as an increase in the counts (e.g., average number of counts) per laser ablation plume, such as when analyzing labeling atoms of a sample or when analyzing an element standard comprising a known quantity of detectable atoms.

In certain aspects, the amount of hydrogen gas flow into the ICP source at an amount that is robust to changes in hydrogen gas flow, such that a 20% change or 50% change in the amount would have less than a 10% change in signal, such as less than a 5% change in signal (e.g., for a standard, for a labeling atom, some labeling atoms, or for all labeling atoms detected at above 10 counts).

Described herein a apparatus and methods for introducing hydrogen containing molecules (such as in a pre-mixed gas or vapor) to improve signal sensitivity and/or stability. In certain aspects, the introduction of hydrogen improves signal stability such that the external humidity across a range (e.g., between 0-2000 or between 0 to 4000 microbars) has less than a 10% or less than a 5% change in signal sensitivity.

Hydrogen Gas for Signal Enhancement

In certain aspects, an apparatus, method and/or a pre-mixed compressed gas source may be provided for introducing hydrogen gas to an ICP torch, such as to improve signal sensitivity and/or signal stability.

In certain aspects, an apparatus comprises one or more of: a sample stage configured to move a sample in at least two directions; a laser ablation source configured to ablate a sample mounted on the sample stage; an inductively coupled plasma (ICP) torch; an injector configured to transport ablation plumes produced from the sample by the laser ablation source to the ICP torch; and a compressed pre-mixed gas source comprising a hydrogen gas in mixture with at least one of helium and argon.

The hydrogen gas in the compressed pre-mixed gas source may between 0.1% and 5% by volume, such as between 1% and 4% by volume.

The compressed pre-mixed gas source may be at least 50% helium by volume or at least 50% argon by volume. The compressed pre-mixed gas source may supply gas to an ablation chamber comprising the sample stage. The pre-mixed gas source may provide a capture gas that carries the ablation plume into the injector. Alternatively or in addition, the pre-mixed gas source may provide a transfer gas (i.e., that enters the injector upstream of the ablation plume), a make-up gas (i.e., that supplements gas in the injector downstream of where the ablation plume enters the injector), and/or an inner gas (i.e., an auxiliary gas, which flows to an inner tube of the ICP torch).

An additional gas source may provide a transfer gas to the injector, such as when the capture gas lifts the ablation plume into the transfer gas in the injector. The transfer gas may include argon (e.g., at least 50% argon). The capture gas may include a mixture of helium and hydrogen gas (e.g., at least 50% helium), or a mixture of argon (e.g., at least 50% argon) and hydrogen gas.

In certain aspects may be no separate capture and transfer gas, such as when only a capture gas enters the injector. In certain aspects, the injector is configure to direct a laser ablation plume to a vertical ICP torch, such as when the apparatus comprises a vertically oriented ICP torch.

The apparatus may further comprise an additional gas source that provides at leas one of a transfer gas, a make-up gas, an inner (auxiliary) gas, and/or an outer (plasma) gas. The additional gas source may be a compressed gas or a liquid dewar, and may be at least 50% argon by volume, and the pre-mixed gas source comprises at least 50% helium by volume. In contrast, the pre-mixed gas source may not be in a liquid dewar as the different gases may evaporate (and therefore be depleted) at different rates during operation.

When the apparatus comprises a make-up flow to the injector downstream of where the laser ablation plume enters the injector, the make-up flow may optionally further be downstream of a sacrificial flow.

In certain aspects, the compressed pre-mixed gas source provides at least one of a capture gas, a transfer gas, and an inner torch gas.

The apparatus may be configured to provide a hydrogen gas flow between 0.001 L/min and 0.1 L/min into the ICP torch, such as a hydrogen gas flow between 0.001 L/min and 0.02 L/min. Alternatively or in addition, hydrogen gas may be between 0.002% and 1% of the total gas flow into the ICP torch, such as between 0.01% and 0.1% of the total gas flow into the ICP torch. The total gas flow into the ICP torch may be between 5 and 30 L/min, such as between 10 and 25 L/min. For example, U.S. Pat. No. 8,633,416, which is incorporated by reference, reports a gas flow around 5 L/min. In certain aspects, the hydrogen gas flow to the ICP torch may be changed by more than 20%, such as by more than 50% without reducing sensitivity (e.g., for one, some or all labeling atoms) by more than 5%. In certain aspects, the amount of hydrogen gas flow to the ICP torch during sample analysis may change by more than 10%, by more than 20%, or by more than 50%.

The apparatus may further include a mass spectrometer configured to detect ionized atoms produces by the ICP torch, as described further herein. In certain aspects, the mass spectrometer comprises a high pass filter configured to remove at least ions of mass 80 amu and less.

The ICP torch is configured to atomize and ionize whole cells in a cell suspension mode in which the ICP torch is decoupled from the laser ablation source. For example, the ICP torch may be decoupled from the laser ablation source, and is sufficient to atomize and ionize whole cells introduced in a suspension to a spray chamber upstream of the ICP. The characteristics of the ICP torch, such as size and geometry, may be suitable for atomizing and ionizing whole cells. Due to this design consideration, the ICP torch may be less efficient at atomizing and/or ionizing material in a laser ablation plume, such as a plume produced by a laser with a spot size less than 2 microns, such as a spot size less than 1 micron.

The apparatus of any of the above embodiments may further include a humidification system (e.g., as described further herein) configured to humidify a gas flow.

A method of the subject application may include analyzing a sample by LA-ICP-MS using the apparatus of any of the above aspects. The sample may be a biological sample as described further herein, such as a tissue section. The sample may include labelling atoms as described further herein, such as labeling atoms associated with a SBP that binds a target in the sample. As such, a method of analyzing may further comprise labelling the sample with labelling atoms prior to analyzing the sample by LA-ICP-MS. In certain aspects, no labeling atom has an oxide spillover of more than 3%.

In certain aspects, the hydrogen gas provides at least a 20% increase in sensitivity for at least some labeling atoms, or at least a 50% increase in sensitivity for at least some labeling atoms, such as for labeling atoms with an average ion count of at least 10 per ablation plume.

In certain aspects, the average sensitivity for a labeling atom (or element standard) in any given 5 minute period may not change by more than 10% over at least an hour of analyzing the sample.

While hydrogen gas is described above, another hydrogen containing gas may be used in place of, or in addition to, hydrogen gas in any of the above aspects. For example, methane or ammonia may be used in place of, or in addition to, hydrogen gas.

Pre-mixed Gas Source and Its Use

Aspects of the subject application include a compressed pre-mixed gas source for an inductively coupled plasma apparatus. The pre-mixed gas source may include helium or argon of at least 50% by volume (e.g., at least 70% by volume, at least 90% by volume) and may further comprise a gas of at least 0.1% by volume, wherein the gas includes the element hydrogen. The gas may be, for example, hydrogen gas, ammonia and/or methane.

In certain aspects, the gas comprises hydrogen gas. The pre-mixed gas source may comprise hydrogen gas between 0.1 and 5% by volume, such as between 1 and 4% by volume. The pre-mixed gas source may comprise hydrogen gas below the flammability point (e.g., less than around 4%). The pre-mixed gas source may be a compressed gas cylinder for use in LA-ICP-MS.

Aspects include a LA-ICP-MS system comprising a compressed pre-mixed gas source described above. In certain aspects, the mass spectrometer may instead be an elemental analyzer, such as an optical emission spectrometer.

Gas Humidification for Signal Enhancement

Aspects of the subject application include apparatus and methods of gas humidification for LA-ICP-MS.

In certain aspects, An apparatus includes one or more of: a sample stage configured to move a sample in at least two directions; a laser ablation source configured to ablate a sample mounted on the sample stage; an inductively coupled plasma (ICP) source; an injector configured to transport ablation plumes produced from the sample by the laser ablation source to the ICP torch; and a humidification system configured to humidify a gas flow.

The gas flow may include one or more of a transfer gas flow, a capture gas flow, a make-up gas flow, and an auxiliary gas flow. In certain aspects, the gas flow is a transfer gas flow.

In certain aspects, the gas flow comprises at least 50% argon (such as at least 70% or at least 90% Argon), such as when the gas flow is a transfer gas. Alternatively, the gas flow may comprise at least 50% helium, such as when the gas flow is a capture gas.

In certain aspects, the humidification system has with a tunable range that covers at least 500 μm (microbars) to 5000 uB, such as between 1000 uB and 4000 uB or between 1500 uB and 3000 uB. This may produce humidified gas with stability better than 20%, such as better than 20%. In certain aspects, the humidity is not controlled within a range of less than 3%, such as less than 5%, as such control may not be necessary for signal stability.

The humidification system may include water diffusion tubing. In certain aspects, the humidification system controls the temperature of the diffusion tubing. Alternatively or in addition, the humidification system includes a variable splitter adjustable to divert gas flow (e.g., flow of an Argon gas) around the water diffusion tubing. The variable splitter may be adjusted by a controller coupled to a humidity sensor. In certain aspects, a controller and humidity sensor together configured to divert flow gas flow around the diffusion tubing to maintain a humidity level. Alternatively to diffusion tubing, the humidification system may include a water pump configured to directly inject water into the gas flow.

A method may include analyzing a sample by LA-ICP-MS using the apparatus comprising any suitable humidification system, such as a humidification system of one of the aspects described above.

The sample may be a biological sample as described further herein, such as a tissue section. The sample may include labelling atoms as described further herein, such as labeling atoms associated with a SBP that binds a target in the sample. As such, a method of analyzing may further comprise labelling the sample with labelling atoms prior to analyzing the sample by LA-ICP-MS. In certain aspects, no labeling atom has an oxide spillover of more than 3%. For example, a high humidity may lead to a higher than 3% oxide spillover. As such, the humidity and/or plasma temperature may be maintained at a level to allow for sensitivity improvement as described below, but may be low enough to avoid oxide spillover (e.g., average oxide spillover during any 5 minute period of a sample run) of more than 3% for any labeling atom. For example, temperature may controlled by adjusting the plasma temperature via the make-up gas flow. Even a small amount of humidity may lead to very high oxides if the temperature is not appropriately controlled.

In certain aspects, the humidification provides at least a 20% increase in sensitivity for at least some labeling atoms, or at least a 50% increase in sensitivity for at least some labeling atoms, such as for labeling atoms with an average ion count of at least 10 per ablation plume (e.g., after preprocessing). In certain aspects, the average sensitivity for a labeling atom (or element standard) in any given 5 minute period may not change by more than 10% over at least an hour of analyzing the sample. In certain aspects, the humidity may be changed by more than 20%, such as by more than 50% without reducing sensitivity (e.g., for one, some or all labeling atoms) by more than 5%.

While gas humidification (with water vapor) is described above, another hydrogen containing molecule may be introduced into a gas flow as a vapor as an alternative, or in addition to, water. For example, an alcohol such as ethanol may be introduced into the gas flow by any of the aspects, such as diffusion tubing, described above for water vapor.

A typical laser ablation inductively coupled plasma device uses a combination of gas flows to carry ablated material from the ablation point to the plasma. The sensitivity is affected by the amount of moisture in the gas flows. Adding water to gas flow via nebulized water mist disrupts the flow and in an imaging application would negatively effect transient signals and pixel rate. Humidifying the gas flow before entering the machine does not pose this issue. Normally ensuring a stable humidity would involve significant temperature stabilization. Humidity of the outlet gas flow may be measured to provide feedback to the humidifier to regulate the humidity. The humidifier itself is a gas flow through diffusion tubing. The flow through the tubing exits saturated so the inventors use a variable gas splitter to vary the flow through the diffusion tubing and thus vary the moisture in the gas flow after recombining. Varying the gas flow is a mechanism of feedback.

Apparatus and Methods for Supplying Hydrogen for Signal Enhancement

Aspects of the subject application include apparatus and methods for introduction of a hydrogen containing molecule into an ICP torch in LA-ICP-MS. The hydrogen-containing molecule may be a gas, such as hydrogen gas, ammonia or methane. Alternatively or in addition, the hydrogen-containing molecule, such as a water or alcohol (e.g., ethanol), may be introduced to a gas flow as a vapor.

Aspects include an apparatus including one or more of: a sample stage configured to move a sample in at least two directions; a laser ablation source configured to ablate a sample mounted on the sample stage; an inductively coupled plasma (ICP) torch; an injector configured to transport ablation plumes produced from the sample by the laser ablation source to the ICP torch; and a compressed pre-mixed gas source comprising a hydrogen containing gas in mixture with at least one of helium and argon. In certain aspects, the hydrogen containing gas is methane, ammonia, or hydrogen gas

Aspects include an apparatus including one or more of: a sample stage configured to move a sample in at least two directions; a laser ablation source configured to ablate a sample mounted on the sample stage; an inductively coupled plasma (ICP) source; an injector configured to transport ablation plumes produced from the sample by the laser ablation source to the ICP torch. The apparatus may be configured to supply a vapor comprising a hydrogen gas flow. The vapor may include a water vapor or an alcohol vapor (e.g., such as ethanol).

Aspects include an apparatus including one or more of: a sample stage configured to move a sample in at least two directions; a laser ablation source configured to ablate a sample mounted on the sample stage; an inductively coupled plasma (ICP) torch coupled to a mass spectrometer; an injector configured to transport ablation plumes produced from the sample by the laser ablation source to the ICP torch. The apparatus may be configured to supply a hydrogen-containing molecule to a plasma (e.g., as described elsewhere herein) of the ICP torch during operation for laser ablation ICP mass spectrometry, but not during the cell suspension mode. In cell suspension mode, the ICP torch may be decoupled from the laser ablation source, and may be sufficient to atomize and ionize whole cells introduced in a suspension to a spray chamber upstream of the ICP.

### EXPERIMENTAL

Inventors have found that signal stability and enhancement for lanthanides and other labeling atoms in a biological sample or inorganic sample (e.g., element standard) can be achieved with a low amount of hydrogen. Hydrogen may be a hydrogen gas (less than flammability limit), and this stability and enhancement can be robust to differences in the amount of hydrogen gas (e.g., due to change in gas flows during operation to maintain a constant plasma). Alternatively, hydrogen may be introduced as a water vapor, and signal stability and enhancement may likewise be robust to a range of humidity.

Inventors observed the sensitivity of the IMC (Fluidigm Hyperion Imaging System) decaying during operation and recovering while turned off. Inventors determined that this was due to small amounts of moisture diffusing into the system, accumulating during down time and slowly drying out during operation. This led to recommendations to decrease the ways of moisture diffusion into the system but also a need to humidify the gas flows in the system. Upon investigation inventors found that the important factor was the amount of hydrogen in the system. Inventors initially dismissed the idea of mixing pure hydrogen into the injector gases as too expensive due to extra gas handing concerns and safety precautions. Inventors first developed an Argon flow humidifier setup. It can provide a stable supply of H₂O at the required level. However, the image analysis by biology experts revealed a concern about images on mass channels contaminated by oxide formation. The oxygen in this case came from water molecules in argon flow. Inventors then decided to explore a way to get the benefit of pure hydrogen mixed into injector flow without added oxygen, but in a configuration that removes flammability and safety concerns. Inventors realized that a pre-mixed gas dilute to non-flammable level can be managed by existing gas handing components and provides sufficient concentration of hydrogen to boost sensitivity and stabilize the signal.

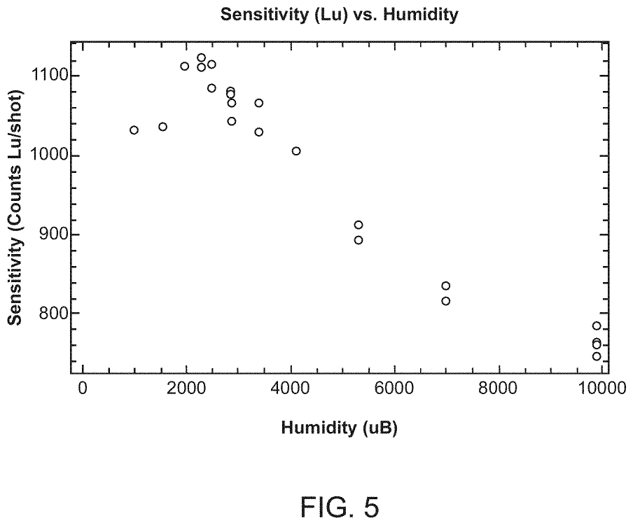

Initially, inventors found that signal was sensitive to humidity, and my fluctuate with external humidity (e.g., of air in the space of the LA-ICP-MS instrument). As shown in FIG. 5, a humidity range of 0 to 4000 uB (microbars) of the transfer gas accounts for about a 30% change in sensitivity of an Lutetium containing element standard, measured as average Lutetium counts per ablation shot across a range of humidities. However, inventors also noticed that signal is stable and high within a range of humidity (around 2000 to 3000 uB). The system used was similar to that shown in FIG. 4.

Inventors also found that addition of water would lead to much higher oxide levels, but that the flow rate of the transfer gas could be adjusted to keep the oxides to a particular level, as opposed to simply tuning for maximum sensitivity. Below is a sample tuning result, showing one can limit oxide ratios to <3% (or less, such as <2% or <1%) while still achieving the significant improvement in sensitivity we're after with the humidifier:

| Humidified | | | Oxide | |
|---|---|---|---|---|
| gas flow rate | Ce140 | Gd156 | ratio | Lu175 |
| 0.80 | 183 | 1 | 0.5% | 1093 |
| 0.81 | 184 | 1 | 0.5% | 1146 |
| 0.82 | 187 | 1 | 0.5% | 1202 |
| 0.83 | 190 | 2 | 1% | 1227 |
| 0.84 | 197 | 5 | 2.5% | 1335 |
| 0.85 | 183 | 7 | 3.8% | 1318 |

One additional note is that Ce140 to Gd156 is typically where oxide spillover is the worst out of all mass channels, so limiting oxide spillover to <3% on that channel during tuning would see much less on other channels. In certain aspects, oxide spillover changes by less than 1 percentage point, such as less than 0.5 percentage points or less than 0.25 percentage points during a sample run e.g., during a period of more than 5 minutes, more than 10 minutes, or more than 30 minutes of a sample run).

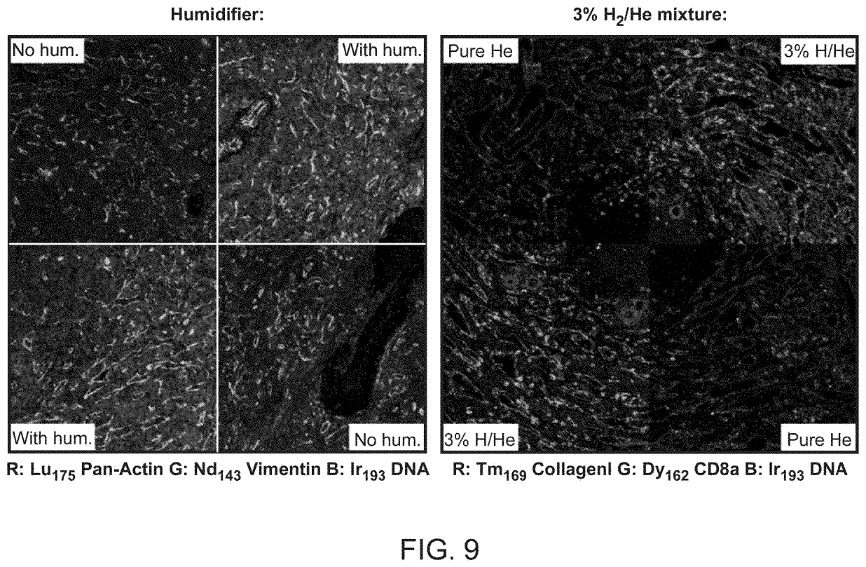

Inventors have also confirmed that addition of hydrogen (H₂) gas (in a pre-mixed gas source with Helium, where hydrogen gas is at 3%) correlates strongly with increased signal/ion image brightness. Signal enhancement for both approaches is shown in FIG. 9. Specifically, transfer gas humidification (left) shows improved signal for common markers, and pre-mixed hydrogen-helium capture gas (right) also shows improved signal for common markers.

Inventors also found that very dim channels experience less sensitivity improvement than bi at channels, possibly due to background. As such, sensitivity improvement may be see mainly for channels detected at an average of 10 or more ion counts per ablation shot,

A comparison of trade-offs for these two approaches are below.

| | Humidifier | H₂/He mixture |
|---|---|---|
| Sensitivity improvement | Yes | Yes |
| Sensitivity stability | Yes | Yes |
| Oxide spillover | Yes | No |
| Hardware needed | Humidifier | None |
| Software needed | Humidifier control, tuning | None |
| Maintenance needed | Minimal | None |

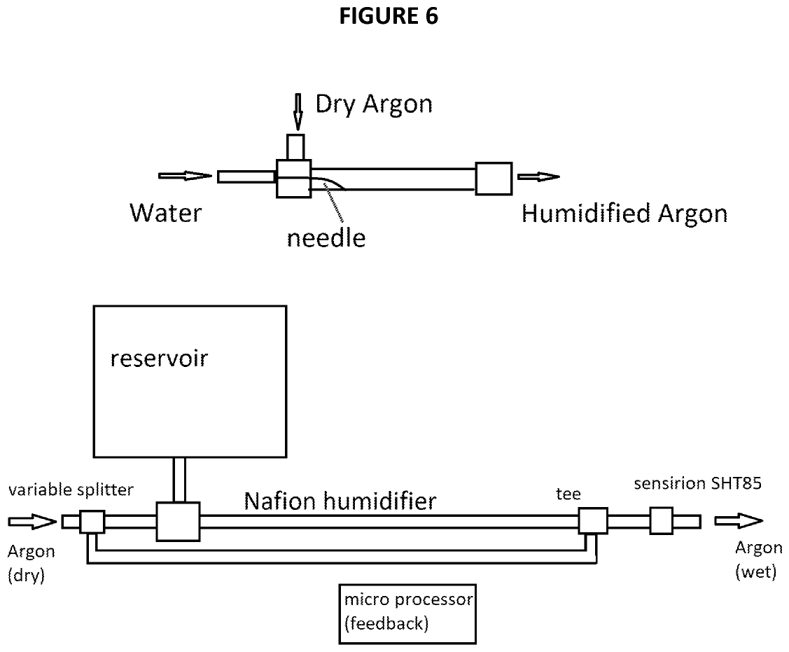

Inventors tried multiple humidification systems as shown in FIG. 6, and found that the direct injection of water with a water pump (FIG. 6 top) leads to some stability issues related to the wetting and droplet formation at the end of the capillary. Flowing gas through diffusion tubing (FIG. 6 bottom) with temperature and/or humidity feedback to control diversion of gas flow around the diffusion tubing was found to provide better humidification stability. An overnight run at a constant rate while temperature stabilizing the diffusion tube gives a pretty stable signal despite the humidity varying by +/−10% (as shown in FIG. 7). However, removing the temperature stabilization and instead using feedback to the gas flow may provide better control of the humidity. Humidity is controlled by changing the gas flow through the diffusion tubing in response to a humidity detected by a sensor downstream of the tubing. Controlling the flow of gas through diffusion tubing provides more consistent humidity and good response time to changes.

A typical laser ablation inductively coupled plasma device uses a combination of gas flows to carry ablated material from the ablation point to the plasma. The sensitivity is affected by the amount of hydrogen in the gas flows.

Inventors have used varying amounts of hydrogen gas to determine the appropriate amount of hydrogen needed for the LA-ICP-MS system similar to that shown in FIG. 4. They used a mixed gas ratio for our helium-hydrogen gas flow that will provide an appropriate amount of hydrogen over the typical range of helium flows. This allows one to switch to a hydrogen mixed gas system with no other changes to the hardware or software other than removing the pure helium and substituting the mixed hydrogen-helium gas. The total number of cylinders/regulators/mass flow controllers is the same. Unlike the humidifier system the mixed gas system does not add oxygen and the oxide ratios detected by the MS system were not affected.

In an alternative setup, the hydrogen is pre-mixed into argon (such as a gas source specifically for the transfer gas and/or capture gas). In some LA-ICP-MS systems the argon can be used as a capture gas for ablated plume. In addition to LA-ICP-MS, in mass cytometry instrumentation. Neon can also be considered for some applications, though it may be prohibitively expensive. In yet another alternative setup, the hydrogen pre-mixed into the argon is added to the transfer gas. The transfer gas is a portion of the total injector flow; it gets mixed with the ablation capture gas carrying the plume. With H2/argon premix added to the transfer gas flow user can change the proportion between the pure argon and H2/Ar premix and control the overall flow of H2 into injector while independently controlling the optimal Argon flow. In other words, the flow of premix controls the mass flow of H2 and the flow of premix plus remaining argon flow controls the total argon flow of the transfer gas. The overall argon flow at the output of the injector needs to be carefully tuned to achieve optimal plasma temperature and maximum sensitivity. The level of H2 then provides a second dimension for sensitivity improvement. Proposed H2/argon premix is of low concentration of hydrogen and below the flammability limit. This setup has a downside that an additional cylinder of premix gas and an independent additional mass flow controller is needed for premix flow. But, the benefit of this setup is the ability to independently control and tune the hydrogen portion of the total flow for a given instrument and plasma conditions. For instance, this arrangement is viewed as Plan B for Deuterium project with H2/Helium premix being Plan A. The H2/Helium mix is low cost and simple solution with typically inconsequential limitation of the absence of independent H2 flow control.

1. An apparatus comprising:
a sample stage configured to move a sample in at least two directions;
a laser ablation source configured to ablate a sample mounted on the sample stage;
a plasma source;
an injector configured to transport ablation plumes produced from the sample by the laser ablation source to the plasma source;
wherein at least one of the plasma source and the sample stage are oriented orthogonally to one another.

2. The apparatus of claim 1, wherein the injector is rigid.

3. The apparatus of claim 1 or 2, wherein the injector is straight.

4. The apparatus of any one of claims 1 to 3, wherein the injector inner diameter is less than 1 mm.

5. The apparatus of any one of claims 1 to 4, wherein the injector length is less than 10 cm.

6. The apparatus of claim 5, wherein the injector length is less than 5 cm.

7. The apparatus of any one of claims 1 to 6, wherein the apparatus is configured to direct the laser on a path that does not pass through the injector.

8. The apparatus of any one of claims 1 to 7, wherein the apparatus is operable to deliver at least 1000 discreet ablation plumes to an ICP source per second.

9. The apparatus of any one of claims 1 to 8, Further comprising a mass spectrometer.

10. The apparatus of claim 9, wherein the mass spectrometer is a time-of-flight mass spectrometer.

11. The apparatus of claim 9 or 10, wherein the MS is configured to receive a vertical beam of ions.

12. The apparatus of any one of claims 1 to 11, wherein the sample stage is vertical, and is operable to run in the vertical position.

13. The apparatus of any one of claims 1 to 11, wherein the plasma source is oriented vertically.

14. The apparatus of claim 13, wherein the plasma source is vacuum sealed with the exception of an injector inlet to the plasma source.

15. The apparatus of any one of claims 1 to 14, wherein the plasma source is an ICP source.

16. A method comprising analyzing a sample by LA-ICP-MS using the apparatus of any one of claims 1 to 15.

17. The method of claim 16, wherein the sample is a biological sample.

18. The method of claim 17, wherein the sample comprises labelling atoms.

19. The method of claim 18, further comprising labelling the sample with labelling atoms prior to analyzing the sample by LA-ICP-MS.

20. The method of any one of claims 16 to 19, wherein at least 1000 discreet ablation plumes are analyzed per second.

21. An apparatus comprising:
a sample stage configured to move a sample in at least two directions;
a laser ablation source configured to ablate a sample mounted on the sample stage;
an inductively coupled plasma (ICP) torch;
an injector configured to transport ablation plumes produced from the sample by the laser ablation source to the ICP torch;
a compressed pre-mixed gas source comprising a hydrogen gas in mixture with at least one of helium and argon.

22. The apparatus of claim 21, wherein the hydrogen gas in the compressed pre-mixed gas source is more than 0.1% and less than the flammability limit of Hydrogen.

23. The compressed pre-mixed gas source of claim 21, wherein hydrogen gas is between 1% and 4% by volume.

24. The apparatus of claim 21, 22 or 23, wherein the compressed pre-mixed gas source comprises at least 50% helium by volume.

25. The apparatus of claim 21, 22 or 23, wherein the compressed pre-mixed gas source comprises at least 50% argon by volume.

26. The apparatus of any one of claims 21 to 25, wherein the compressed pre-mixed gas source supplies gas to an ablation chamber comprising the sample stage.

27. The apparatus of any one of claims 21 to 26, wherein the pre-mixed gas source provides a capture gas that carries the ablation plume into the injector.

28. The apparatus of claim 27, wherein an additional gas source provides a transfer gas to the injector, wherein the capture gas lifts the ablation plume into the transfer gas in the injector

29. The apparatus of claim 28, wherein the transfer gas comprises argon and the capture gas comprises a mixture of helium and hydrogen gas.

30. The apparatus of claim 27, wherein there is no separate capture and transfer gas.

31. The apparatus of any one of claims 21 to 30, wherein the injector directs a laser ablation plume to a vertical ICP torch

32. The apparatus of any one of claims 21 to 29, further comprising an additional gas source that provides the transfer gas to the injector.

33. The apparatus of claim 32, wherein the additional gas source comprises at least 50% argon by volume, and wherein the pre-mixed gas source comprises at least 50% helium by volume.

34. The apparatus of any one of claims 21 to 33, wherein the additional gas source is a liquid dewar.

35. The apparatus of any one of claims 21 to 34, wherein the compressed pre-mixed gas flow is configured to introduce a make-up flow to the injector downstream of where the laser ablation plume enters the injector

36. The apparatus of claim 35, wherein the make-up flow is introduced downstream of a sacrificial flow.

37. The apparatus of claim 36, wherein the apparatus does not include a sacrificial flow.

38. The apparatus of any one of claims 21 to 34, wherein the compressed pre-mixed gas source provides at least one of a capture gas, a transfer gas, and an inner torch gas.

39. The apparatus of any one of claims 21 to 38, configured to provide a hydrogen gas flow into the ICP torch is between 0.001 L/min and 0.1 L/min.

40. The apparatus of claim 39, configured to provide a hydrogen gas flow into the ICP torch is between 0.001 L/min and 0.02 L/min.

41. The apparatus of any one of claims 21 to 40, further configured to provide hydrogen gas between 0.002% and 1% of the total gas flow into the ICP torch.

42. The apparatus of claim 41, wherein the apparatus is configured to provide hydrogen gas between 0.01% and 0.1% of the total gas flow into the ICP torch.

43. The apparatus of claim 41 or 42, wherein the total gas flow into the ICP torch is between 5 and 30 L/min.

44. The apparatus of any one of claims 21 to 43, further comprising a mass spectrometer configured to detect ionized atoms produces by the ICP torch.

45. The apparatus of claim 44, wherein the mass spectrometer comprises a high pass filter configured to remove at least ions of mass 80 amu and less.

46. The apparatus of any one of claims 21 to 45, wherein the ICP torch is configured to atomize and ionize whole cells in a cell suspension mode in which the ICP torch is decoupled from the laser ablation source.

47. The apparatus of any one of claims 21 to 46, further comprising a humidification system configured to humidify a gas flow.

48. The apparatus of claim 47, wherein the humidified gas flow is a transfer gas flow.

49. A method comprising analyzing a sample by LA-ICP-MS using the apparatus of any one of claims 21 to 48.

50. The method of claim 49, wherein the sample is a biological sample.

51. The method of claim 50, wherein the sample comprises labelling atoms.

52. The method of claim 51, further comprising labelling the sample with labelling atoms prior to analyzing the sample by LA-ICP-MS.

53. The method of claim 52, further wherein no labeling atom has an average oxide spillover of more than 3%.

54. The method of any one of claims 49 to 53, wherein the hydrogen gas provides at least a 20% increase in sensitivity for at least some labeling atoms.

55. The method of claim 54, wherein the hydrogen gas provides at least a 50% increase in sensitivity for at least some labeling atoms.

56. The method of any one of claims 49 to 55, wherein the average sensitivity for a labeling atom in any given 5 minute period does not change by more than 10% over at least an hour of analyzing the sample.

57. A compressed pre-mixed gas source for an inductively coupled plasma apparatus, comprising:
helium or argon of at least 50% by volume; and
hydrogen gas between 0.1% and 5% by volume.

58. The compressed pre-mixed gas source of claim 57, comprising at least 50% helium by volume.

59. The compressed pre-mixed gas source of claim 57, comprising at least 50% argon by volume.

60. The compressed pre-mixed gas source of claim 55, 56, or 57, wherein hydrogen gas is between 1% and 4% by volume.

61. A compressed pre-mixed gas source for an inductively coupled plasma apparatus, comprising:
helium or argon of at least 50% by volume;
a gas at least 0.1% by volume, wherein the gas comprises the element hydrogen.

62. The compressed pre-mixed gas source of claim 61, wherein the gas is methane, ammonia or hydrogen gas.

63. An apparatus comprising:
a sample stage configured to move a sample in at least two directions;
a laser ablation source configured to ablate a sample mounted on the sample stage;
an inductively coupled plasma (ICP) source;
an injector configured to transport ablation plumes produced from the sample by the laser ablation source to an ICP torch;
a humidification system configured to humidify a gas flow.

64. The apparatus of claim 63, wherein the gas flow comprises a transfer gas flow.

65. The apparatus of claim 63 or 64, wherein the gas flow comprises a capture gas flow

66. The apparatus of any one of claims 63 to 65, wherein the gas flow comprises a make-up gas flow.

67. The apparatus of any one of claims 63 to 66, wherein the gas flow comprises an auxiliary gas flow

68. The apparatus of any one of claims 63 to 67, wherein the gas flow comprises at least 50% argon.

69. The apparatus of any one of claims 63 to 68, wherein the humidification system comprises water diffusion tubing.

70. The apparatus of claim 69, wherein the humidification system controls the temperature of the diffusion tubing.

71. The apparatus of claim 69 or 70, further comprising comprises a variable splitter adjustable to divert gas flow around the water diffusion tubing

72. The apparatus of any one of claims 69 to 72, further comprising a controller and humidity sensor together configured to divert flow gas flow around the diffusion tubing to maintain a humidity level.

73. The apparatus of any one of claims 63 to 68, wherein the humidification system comprises a water pump configured to directly inject water into the gas flow.

74. A method comprising analyzing a sample by LA-ICP-MS using the apparatus of any one of claims 63 to 73.

75. The method of claim 74, wherein the sample is a biological sample.

76. The method of claim 75, wherein the sample comprises labelling atoms.

77. The method of claim 76, further comprising labelling the sample with labelling atoms prior to analyzing the sample by LA-ICP-MS.

78. The method of claim 76 or 77, wherein no labeling atom has an average oxide spillover of more than 3%.

79. The method of claim 76, 77 or 78, wherein the humidification provides at least a 20% increase in sensitivity for at least some labeling atoms

80. The method of claim 79, wherein the humidification provides at least a 50% increase in sensitivity for at least some labeling atoms.

81. The method of any one of claims 73 to 80, wherein the average sensitivity for a labeling atom in any given 5 minute period does not change by more than 10% over at least an hour of analyzing the sample.

82. An apparatus comprising:
a sample stage configured to move a sample in at least two directions;
a laser ablation source configured to ablate a sample mounted on the sample stage;
an inductively coupled plasma (ICP) torch;
an injector configured to transport ablation plumes produced from the sample by the laser ablation source to the ICP torch;
a compressed pre-mixed gas source comprising a hydrogen-containing gas in mixture with at least one of helium and argon.

83. The apparatus of claim 82, wherein the hydrogen-containing gas is methane, ammonia, or hydrogen gas.

84. An apparatus comprising:
a sample stage configured to move a sample in at least two directions;
a laser ablation source configured to ablate a sample mounted on the sample stage;
an inductively coupled plasma (ICP) source;
an injector configured to transport ablation plumes produced from the sample by the laser ablation source to an ICP torch;
wherein the apparatus is configured to supply a hydrogen-containing molecule to a plasma of the ICP torch during operation for laser ablation ICP mass spectrometry.

85. The apparatus of claim 84, wherein the apparatus is configured to supply a vapor comprising a hydrogen gas flow.

86. The apparatus of claim 84 or 85, wherein the vapor comprises a water vapor or an alcohol vapor.

87. The apparatus of claim 86, wherein the vapor comprises a water vapor.

88. The apparatus of claim 86, wherein the vapor comprises an alcohol.

89. The apparatus of claim 88, wherein the alcohol is ethanol.

90. A method comprising analyzing a sample by LA-ICP-MS using the apparatus of any one of claims 84 to 89.

91. An apparatus comprising:
a sample stage configured to move a sample in at least two directions;
a laser ablation source configured to ablate a sample mounted on the sample stage;
an inductively coupled plasma (ICP) torch coupled to a mass spectrometer;
an injector configured to transport ablation plumes produced from the sample by the laser ablation source to the ICP torch;
wherein the ICP torch is configured to atomize and ionize whole cells in a cell suspension mode in which the ICP torch is decoupled from the laser ablation source;
wherein the apparatus is configured to supply a hydrogen-containing molecule to a plasma of the ICP torch during operation for laser ablation ICP mass spectrometry, but not during the cell suspension mode.
